(19) United States
(12) Patent Application Publication
(10) Pub. No.: US 2009/0020393 A1
(43) Pub. Date: Jan. 22, 2009

(54) Impromptuly deployable conveyance system and method

(76) Inventor: Joseph K. Garwood, Edwardsville, IL (US)

Correspondence Address: Klotzer Patents, 4579 Laclede Ave., #210, St. Louis, MO, 63108, US

(21) Appl. No.: 11/880,239

(22) Filed: Jul. 21, 2007

(51) Int. Cl. B65G 21/22

(52) U.S. Cl. 198/345.3

(57) ABSTRACT

Systems for and methods of conveying at least one article in situations that are unprepared for facilitating the conveying. The present invention is impromptuly deployable so as to facilitate conveying an article from one setting to another setting, where the settings and a conveyance path between them are essentially unconstrained other than their possessing capabilities of bearing the article(s) being conveyed and the conveyance path admitting its passage. The present invention facilitates the conveying by mitigating at least one gravitationally related article conveyance complication and is effectively operable immediately upon implementing said impromptu deployment. Multiple embodiments provide differing conveyance capabilities, including adaptability to conveying diverse forms of articles, widely differing conveyance situations, and capacities to fulfill multiple varieties of conveying task requirements.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates generally to systems and methods of article conveying, and more specifically to article conveying systems and methods that are, when in an operative condition, deployable on an impromptu basis and are adaptable, also on an impromptu basis, to conveying situations that are widely varying and generally not modified to facilitate either deploying or conveying.

2. Related Art

A wide variety of undertakings will require that one manages to make available one or more articles at a specified location and/or with a specified disposition by conveying said articles from another location and/or disposition. The terms “article” and “articles”, as used herein, generally denote both singular items that are individually manipulable as well as items of an aggregate or continuous nature. In many cases, the circumstances of the articles involved and/or the situations in which said conveying is entailed are not well suited for accomplishing the article conveyance. Commonly, the primary design requirements of factories that assemble apparatuses from a plurality of constituent parts include ensuring that the factory is arranged for efficient conveying of the various parts and the partially or wholly assembled apparatuses, said parts and apparatuses henceforth being referred to as articles herein. The value of well designed conveying processes is further substantiated by noting that certain successful companies' entire business models are based on their capabilities to improve the design of these conveying processes. Even within the confines of a well designed factory, optimal execution of these conveying processes can necessitate careful regulation of floor levels, article conveying clearances, load distributions, article disposition management, conveyance dynamics, and a host of other factors. The equipment demands for effecting these conveying tasks are hence so challenging that manufacturers provide an almost dizzying array of equipment to aid in achieving these tasks, as illustrated by the online equipment catalog of one such major equipment manufacturer: McMaster-Carr. The McMaster-Carr catalog has over 90 individual product categories in their material handling section, and each of these categories will generally include a substantial number of different specific pieces of equipment. In addition to the variety of conveyance complications demonstrated by this illustration, it is also known that conveyance issues alone can determine whether or not a given production facility is profitable.

Conveyance complications also arise in operational situations that are not well addressed by the existing approaches. In contrast to the aforementioned issues that arise even in controlled situations, still more complications will often arise when it is necessary to conduct a conveying process in a relatively uncontrolled situation. A typical such situation often arises when it is necessary to install a substantial part of a HVAC system in a moderately sized building. In general, a furnace or whole building air conditioning unit is considerably too large for an individual (or two) to carry. An installation of such a unit usually begins with the installers arriving with the unit in a small delivery/equipment truck at the installation location. The truck can generally only get as close as a street or driveway will allow. Operational requirements will ordinarily dictate where and with what disposition the unit must be placed for installation and it is up to the installers to find a way to convey the unit from the truck to the installation position. Rarely, if ever, will there be substantial modifications to the installation locale to facilitate the unit's conveying. The installers potentially may have to cope with a host of unknowns such as unprepared conveyance paths, uncertain terrain, myriad obstacles, gravitationally related conveyance complications (such as lifting an 800 lb. unit in or out of the truck—much less up multiple stories, or friction damaging the unit if it slides across a concrete surface), limited alternative options, and conveyance settings that are often set up for anything but conveying ease. The installers will habitually have to accomplish their task regardless of the complications encountered, and moreover execute the article conveying on an impromptu basis. In the present context, the term impromptu specifically means, as noted on the website www.thesaurus.com (sourced from Roger's New Millennium™ Thesaurus, First Edition (v.1.3.1) with the added note that “this distinction has been all but lost”), “extemporaneous means ‘prepared in advance and carried out with few or no notes’ while impromptu means ‘totally unprepared, performed on the spur of the moment’”. As used herein, this distinction is retained, in the sense that the terms impromptu or impromptuly are used to specifically refer to actions and capabilities that involve essentially no advance preparation nor are they specifically limited to only those selected situations which have been prepared for the conveying to be capable of being executed.

There is a clear need for conveyance systems and conveying methods that are impromptuly deployable. Included among the issues that such conveying approaches could also optimally handle are:
1. Ease of utilization essentially without advance preparations;
2. Applicability to widely varying situations, again essentially without advance preparations;
3. Substantial flexibility of operation with a considerable diversity of articles to be conveyed;
4. Capabilities of easing complications involved in effecting conveyance;
5. Capabilities of aiding the execution of the conveying operation; and
6. Provision of additional capabilities that aid, complement, or extend the range of tasks that relate either to the conveying task at hand, or to tasks that are related to the general undertaking that encompasses the conveying task.

### SUMMARY OF THE INVENTION

The present invention incorporates systems and methods of conveying articles that, in varying embodiments and combinations, are impromptuly deployable, flexibly configurable, multi-functional, and applicable to diverse settings and articles to be conveyed. Included within the scope of the present invention are embodiments that can handle at least one or more of all six of the above mentioned issues, many embodiments are capable of handling more than one, and some embodiments can handle added issues as well. Differing embodiments are generally targeted at differing types of tasks, while more general categories of embodiments include individual embodiments that target types of conveying tasks that are related to the other members of that category. General objectives of the present invention include versatility, ready adaptability, and near unlimited utility. Among the specific objectives described subsequently, certain embodiments will be capable of meeting more than one, while others will be best suited to narrower objectives.

A first objective of the present invention is to provide conveyance systems and methods that are impromptuly deployable with few conveying site restrictions and wider capabilities of handling greater varieties of conveyed article types in wider varieties of conveying situations. The impromptu nature of the deployability of these systems and methods is fundamentally significant in that it provides ready access to conveying facilitation in situations that heretofore could not benefit from such a capability. In addition, even in those situations in which conveying, usually by brute manual labor, could be accomplished prior to the present invention, the gains in time and labor efficiency as well as improved conveying security (in terms of both the conveyed articles' security from damage and the safety from injury of those effecting the conveying) gained with the present invention will provide considerable value.

A second objective of the present invention is to provide conveyance systems and methods that can mitigate at least one complication that will generally arise when conveying. These complications are often gravitationally related in that they are either direct consequences of the weight of the articles (such as conveying a heavy article from a lower to a higher elevation or overcoming substantial sliding friction caused by the weight of the article pressing down upon a high-traction surface); or they are consequences of a conveying issue that is made more problematic by the weight of the article (such as maintaining a heavy article in a specific spatial attitude during conveying or guarding a fragile and difficult to balance article during conveying).

A third objective of the present invention is to provide conveyance systems and methods that can mechanically assist in providing the dynamic requirements of effecting the article conveying, such as by providing mechanisms that can assist the conveying process by amplifying the manual input force with gearings, or by providing arresting mechanisms that can slow or stop the conveying process, particularly in situations when gravity can be harmful to controlled conveying like when unloading a heavy article from a truck to the ground.

A fourth objective of the present invention is to provide conveyance systems and methods that are flexibly configurable, as well as reconfigurable, especially when (or very nearly) operable. Both the flexible configurability and the reconfigurability are preferably both straightforward and adaptable. Either of the flexible configurability and the reconfigurability can be realized by altering the constituent contents of the conveyance system being used, or by altering the manners of arrangements of these constituent contents. While there are a number of approaches described herein to effect this flexible configurability and reconfigurability, of particular note are approaches that utilize modular techniques so that the present invention can readily alter either or both its constituent contents and its constituents' arrangements with standardized interconnections.

A fifth objective of the present invention is to provide conveyance systems and methods that can combine conveying capabilities with supplementary capabilities. Included within the range of these supplementary capabilities are those that relate directly to the conveying process, such as providing a means of securing the articles to be conveyed against shifts in balance, and those that relate to general realms of tasks that are regularly associated with standard conveying situations, such as providing a ladder for use in completing the final installation of an HVAC unit like that described in the earlier description of the background of the invention.

A sixth objective of the present invention is to provide conveyance systems and methods that can provide more than one manner of effecting article conveying. Certain embodiments of these multi-manner conveying systems and methods can realize the article conveying by translation of the article relative to the conveyance system itself, and others can alternatively (or additionally) realize the conveying by loading the article on to the conveyance system and then realizing a system transporting capability to thereby convey the loaded article. Additional manners of realizing the conveying can further operate by employing multiple conveyance systems that are linked in various ways to convey articles along a conveyance path defined by the combined conveyance systems.

A seventh objective of the present invention is to provide conveyance systems and methods that are capable of providing the conveying benefits when operating as a whole, as well as being capable of providing significant auxiliary capabilities when in various states of disassembly. The various states of disassembly can provide both conveying-related capabilities from the balance of the conveying systems and methods, as well as providing supplementary capabilities by aspects of the conveying systems and methods that are detached from the balance of the conveying systems and methods.

Other objects and features will be in part apparent and in part pointed out hereinafter.

### BRIEF DESCRIPTION OF THE DRAWINGS

FIG. 1 is an elevated partially-exploded perspective view of a first flexibly configurable embodiment of the present invention.

FIG. 2 is a quarter side view of a separated mechanical conveyance assistor aspect of the first flexibly configurable embodiment.

FIG. 3 is a perspective view of a first multidirectional conveyance path embodiment of the present invention.

FIG. 4 is a partial detail view of a second multidirectional conveyance path embodiment of the present invention.

FIG. 5 is an exploded perspective view of a third multidirectional conveyance path embodiment of the present invention.

FIG. 6 is a perspective view of a first linkable embodiment of the present invention.

FIG. 7 is an enlarged detail view of a linkage area 7 in FIG. 6 of the first linkable embodiment of the present invention.

FIG. 8 is a perspective view of a second linkable embodiment of the present invention.

FIG. 9 is an enlarged detail view of a linkage area 9 in FIG. 8 of the second linkable embodiment of the present invention.

FIG. 10 is a perspective view of a fourth multidirectional conveyance path embodiment of the present invention.

FIG. 11 is an enlarged detail view of the portion of the fourth multidirectional conveyance path embodiment that is disposed within the circle 11 in FIG. 10.

FIG. 12 is a perspective view of a fifth multidirectional conveyance path embodiment of the present invention.

FIG. 13 is an enlarged detail view of the portion of the fifth multidirectional conveyance path embodiment that is disposed within the circle 13 in FIG. 12.

FIG. 14 is a perspective view of a first selectively facilitating embodiment of the present invention.

FIG. 15 is an enlarged detail view of the portion of the first selectively facilitating embodiment that is disposed within the circle 15 of FIG. 14.

FIG. 16 is also an enlarged detail view of the portion of the first selectively facilitating embodiment that is disposed within the circle 15 of FIG. 14 but with an alternative mechanism for effecting the selective facilitating capability.

FIG. 17 is a partial side view of a second selectively facilitating embodiment of the present invention.

FIG. 18 is an enlarged detail side view of the portion of the second selectively facilitating embodiment that is disposed within the circle 18 of FIG. 17.

FIG. 19 is an enlarged detail overhead view of approximately the portion of the second selectively facilitating embodiment that is shown in FIG. 18.

FIG. 20 is a detail lower perspective view of a third selectively facilitating embodiment of the present invention.

FIG. 21A is a detail side view of a portion of a circulating articulated lateral rail embodiment of the present invention and FIG. 21B is a detail front view of approximately the same portion of the circulating articulated lateral rail embodiment of the present invention shown in FIG. 21A.

FIG. 22 is a partial perspective view, in situ with an article to be conveyed, of the circulating articulated lateral rail guide embodiment of the present invention.

FIG. 23 is a full perspective view, in situ with an article to be conveyed, of the circulating articulated lateral rail embodiment of the present invention.

FIG. 24 is a perspective view of a first composite conveying embodiment of the present invention.

FIG. 25 is a partially exploded perspective view of a second flexibly configurable embodiment of the present invention.

### DETAILED DESCRIPTION OF THE PREFERRED EMBODIMENTS

In the following description, identical numbers indicate identical elements. Where an element has been described in one Figure, and is unaltered in detail or relation in any other Figure, said element description applies to all Figures.

In general, conveyance systems according to the present invention are capable of facilitating conveyance of at least one article in at least one conveyance facilitating direction and are accordingly deployed in a stable conveying disposition, so that at least one of said conveyance facilitating directions is disposed at least partially along at least a portion of an article conveyance path. The systems and methods according to the present invention typically effect the conveyance facilitating by providing capabilities of at least partially supporting the article(s) being conveyed, and by further providing capabilities of mitigating at least one conveying related complication by combining the mitigating action with the supporting action. The conveying related complication is commonly manifested as a gravitationally related complication, such as an especially heavy article that needs conveying between positions of differing heights or as a very fragile and bulky article that is difficult to maintain in a specific vital orientation that is unstable due to the article's weight distribution being unbalanced. The majority of conveying complications addressed by the present invention are characterizable as being gravitationally related in that they would be effectively suppressed in the absence of gravity, although it should be understood that the present invention is not to be construed as being exclusively limited to addressing only those complications that are gravitationally related. The stable conveying disposition is essentially determined by characteristics of the conveying situation and the article(s) to be conveyed. The principal pertinent conveying situation characteristics include:
1. The settings which the article is to be conveyed between;
2. The environmental factors capable of affecting article conveying;
3. Article attributes which present constraints on the deploying situation (such as an article that is damaged by moisture and hence should not be conveyed in the rain without shelter);
4. Article attributes which present constraints upon the conveyance system (such as an article that requires maintenance of a particular orientation during conveying and thereby requires the conveyance system to only be deployed with certain attitudes); and
5. The presence of deploying situation properties sufficient to enable the conveyance system to be deployed in the stable conveying disposition with the capability of providing said at least partial support for the article to be conveyed.
   When the deploying situation and article characteristics allow, the stable conveying disposition essentially entails only establishing the conveyance system with at least three non-collinear base points in securely supported dispositions which are capable of collectively bearing the conveyance system and the article(s) being conveyed. The base points are points that the conveyance system (and any articles being conveyed) can be bom upon such that the conveyance system is capable of providing said supporting for the article(s) being conveyed. In general, much of the area of the non-conveying side of the conveyance system is capable of firnishing points that can function as the base points.

The article's conveyance path is characterized as a path that the article is capable of traversing and that interconnects at least first and second settings capable of bearing the articles to be conveyed. The article's capability of traversing the conveyance path is primarily determined by a lack of spatial constraints that the article cannot traverse. An example of such a spatial constraint would be a 4 foot wide, deep, and high article attempting to traverse a conveyance path that passes through a 2 foot wide space between structures. The first setting is characterized as the article's pre-conveying location, the second setting is characterized as the article's post-conveying location, and the settings' capabilities of bearing the article involve their ability to maintain the article in an acceptable disposition. An example of an unacceptable second setting for an article would be, in the case of an article that is a large, fragile glass sculpture, when the second setting is 45 degree sloping hillside composed of loose gravel. Evidently, the suitability of a particular conveyance path and first and second settings is highly variable and depends greatly on the article being conveyed.

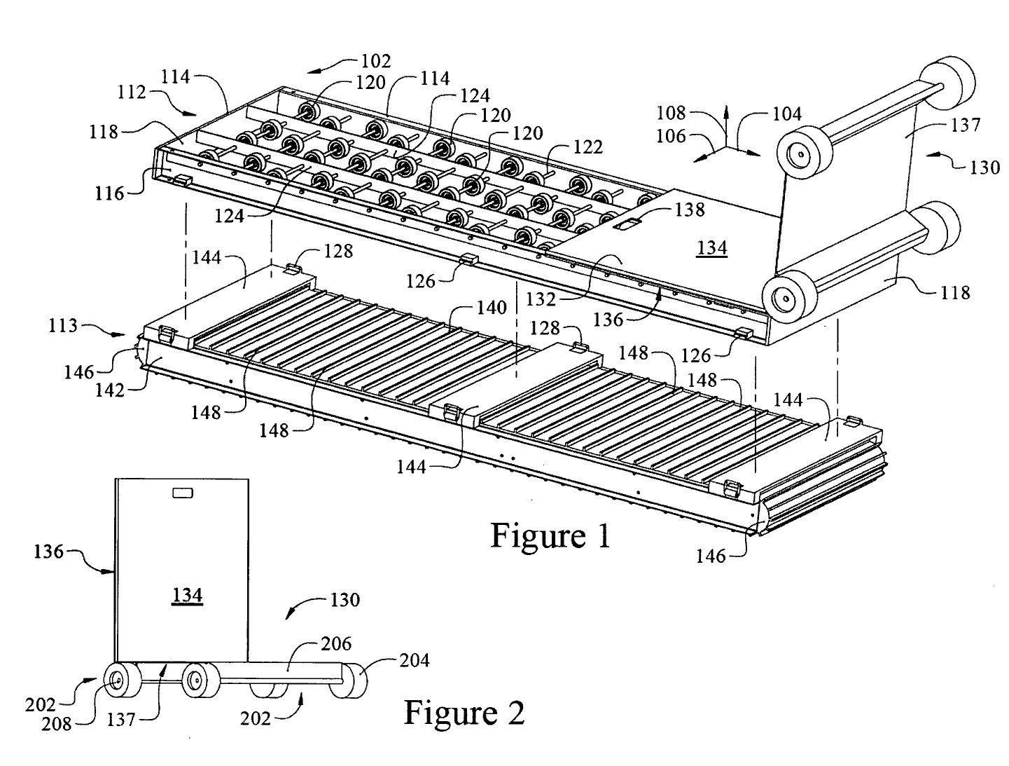

In FIG. 1, and succeeding figures when applicable, embodiments of the present invention are variously described in relation to a set of first framework coordinates 102 comprising first dimension 104, second dimension 106, and third dimension 108, wherein each dimension's nominally positive direction is indicated by the arrow that delineates that dimension. Unless otherwise specified or evident, reference to one or more of the first framework coordinates 102 can refer to their nominally positive direction and/or their nominally negative direction or both. The first framework coordinates 102 are variously applicable both to descriptions of embodiments of the present invention as well as to descriptions of conveying actions. Referring initially to FIG. 1, a first flexibly configurable embodiment 110 is shown in a partially exploded state with a first conveyance constituent 112 offset from a first supplementary component 113. The first conveyance constituent's 112 structural basis is defined by a first framework 114 that is comprised of a pair of substantially parallel, spaced apart lateral rails 116 extending in the first framework first dimension 104, and a pair of substantially parallel, spaced apart end rails 118 extending in the first framework second dimension 106. In addition to the shown configuration in which the first flexibly configurable embodiment's 110 lateral rails 116 and end rails 118 have substantially rectilinear dimensions, and in which adjacent rails are disposed substantially perpendicularly to each other, it is also capable of being configured in alternative manners (not shown) wherein at least one of the rails is not rectilinear and/or at least two adjacent rails are not perpendicularly disposed. An array of rotatable wheels 120 are capable of functioning as mechanical conveyance facilitators for an article that is being conveyed. The rotatable wheels 120, as well as any other mechanical conveyance facilitators utilized in the various embodiments, along with the other portions of the embodiments of the present invention that serve to contribute support for the mechanical conveyance facilitators are collectively characterized as the supporting portions of the present invention. The rotatable wheels 120 revolve about axles 122 that are disposed between the lateral rails 116, said axles 122 being optionally reinforced by reinforcing braces 124. The inclusion of reinforcing braces 124, the number included, and their strength of construction are selected in accordance with the conveyance system's projected conveying requirements, specifically including the magnitude of its projected supporting capabilities and the projected usability limits caused by the conveyance system's escalating weight (since increasing the reinforcing braces' 124 strength and/or number will inherently also increase the weight of the conveyance system). The rotatable wheels' 120 and axles 122 are disposed so that the outer perimeters of the rotatable wheels 120 extend sufficiently far enough in the positive first framework third dimension 108 to reach beyond the balance of the first framework's 114 reach in the first framework third dimension 108, but do not extend in the negative first framework third dimension 108 beyond the reach of the balance of the first framework 114. By reaching farther in the first framework third dimension 108, said at least partial support provided by the first framework 114 is communicated to an article being conveyed by the rotatable wheels 120. First framework latches 126 and first supplementary component latches 128 are cooperatively operable to provide capabilities for selectively attaching and detaching the first framework 114 and the first supplementary component 113. There is a large assortment of well known latch mechanisms that would provide the selective attaching detaching capabilities, such as a style F draw latch distributed by the McMaster-Carr Supply Company and detailed on page 2822 of their on-line catalog at the URL: “http://www.mcmaster.com/”. The capability of the first flexibly configurable embodiment 110 to selectively attach the first conveyance constituent 112 and the first supplementary component 113 also enables this embodiment to be modularly constitutable meaning that it's constitution is determinable by selectively combining differing modular constituents such as combining the first conveyance constituent 112 and the first supplementary component 113. This modular constitutability enables substantial variability in how conveyance systems according to the present invention are configured, and most of the various aspects of the embodiments described herein are combinable with other aspects by suitable utilization of these modular capabilities.

As shown in FIG. 1, the first flexibly configurable embodiment 110 includes two optional constituents: the first supplementary component 113 and a first ancillary mechanical conveyance assistor 130. The first ancillary mechanical conveyance assistor 130 is optionally separable from the balance of the first flexibly configurable embodiment 110 and is shown in FIG. 2 in such a separated state. The first ancillary mechanical conveyance assistor 130 is capable of being configured in varying ways, and the particular details shown in FIG. 1 are depicted for illustrative purposes only, and should not be construed as limiting. A primary aspect of the first ancillary mechanical conveyance assistor 130 is a primary planar mechanical interface 132 that has an article primary planar interface side 134 and a conveyance system primary planar interface side (not shown) that is opposite of the article primary planar interface side 134. When the first ancillary mechanical conveyance assistor 130 is disposed in an unseparated state, as shown in FIG. 1, the conveyance system primary planar interface side 136 will generally be facing and at least partially supported by the rotatable wheels 120, with the article primary planar interface side 134 facing away from the balance of the first conveyance constituent 112 and thereby available for at least partially supporting at least one article to be conveyed. The article so supported would generally move in concert with the first ancillary mechanical conveyance assistor 130, and the first flexibly configurable embodiment 110 then mitigates at least one gravitationally related article conveyance complication by the rotation of the rotatable wheels 120 facilitating movement of the ancillary mechanical conveyance assistor 130 relative to the first framework 114. Optionally, the ancillary mechanical conveyance assistor 130 can also be configured with lateral guides (not shown) on its first framework second dimension 106 outer side edges that interrelate with slots (not shown) running along the first framework's second dimension 106 outer side edges to provide additional conveying motion control by constraining the ancillary mechanical conveyance assistor 130 to moving essentially only in the first framework first dimension 104 direction. Alternatively, the ancillary mechanical conveyance assistor 130 can be configured with slots and the first framework 114 configured with the guides, as well as a number of other similarly functioning well known cooperative arrangements that can provide said ancillary mechanical conveyance assistor 130 movement constraining effect. The ancillary mechanical conveyance assistor 130 as shown in FIGS. 1 & 2 is configured with an optional secondary planar interface 137 dispositioned at an approximately right angle to the primary planar interface 132. The juncture between the secondary planar interface 137 and the primary planar interface 132 can be dispositioned along a first framework first dimension 104 side, as shown, as well as a first framework second dimension 106 side (not shown) of the primary planar interface 132. The interrelation between the primary and secondary planar interfaces 132 and 136, respectively, can be a fixed juncture as shown in FIGS. 1 & 2, or can alternatively be an articulating juncture (not shown) such as a pivoting hinge, that allows the primary and secondary planar interfaces 132 and 136, respectively, to assume varying relative dispositions. Additionally, the interrelation can also be detachable in any of a variety of well known ways so that the ancillary mechanical conveyance assistor 130 is alterably configurable with said primary planar interface 132 being optionally interrelatable with additional planar interfaces. A primary planar interface aperture 138 can be utilized to assist the motion of the ancillary mechanical conveyance assistor 130 relative to the first framework 114, by its utilization as a handhold or as a fastening point for a winch or other mechanism.

Referring next to FIG. 2, the ancillary mechanical conveyance assistor 130 is shown detached from the first flexibly configurable embodiment 110 in a separated disposition wherein it is capable of providing an article translating function. When in the separated translating disposition, the ancillary mechanical conveyance assistor 130 will be typically arranged with the primary planar interface 132 positioned generally normal to the underlying surface it is traversing and the secondary planar interface 137 positioned generally parallel to the underlying surface so that the article being translated can be at least partially supported by the secondary planar interface 137. As depicted in FIGS. 1 & 2, the ancillary mechanical conveyance assistor 130 is configured with optional translation facilitating components 202. In the first flexibly configurable embodiment 110 shown in FIGS. 1 & 2 the pair of translation facilitating components 202 each comprise a pair of rolling wheels 204 and a rolling wheels suspension member 206 that interconnects with the secondary planar interface 137. The rolling wheels suspension member 206 maintains sufficient offset between the rolling wheels axle 208 and the secondary planar interface 137 so that when an article being translated is supported by the secondary planar interface 137 the perimeter of the rolling wheels 204 will not be in contact with said article. The ancillary mechanical conveyance assistor 130 is hence utilizable for translating an article to and/or from the first flexibly configurable embodiment 110, when in said separated disposition, by at least partially supporting an article upon the secondary planar interface 137 and translating the ancillary mechanical conveyance assistor 130 and article upon said rolling wheels 204. The ancillary mechanical conveyance assistor 130 is further capable of assisting in loading or unloading article(s) to or from the first flexibly configurable embodiment 110 in a variety of manners including, when the article is interrelated with the ancillary mechanical conveyance assistor 130 such that its movement will communicate with the article to induce the article to effect a corresponding movement, by suitably rotating about the juncture between the primary planar interface 132 and the secondary planar interface 137. Said rotating about the planar interfaces' juncture will generally transition between when the article is suitably dispositioned for conveying wherein the article is at least partially supported by the primary planar interface 132 which is then generally parallel to and at least partially supported by the first conveyance constituent 112, and when the article is suitably dispositioned for translating wherein it is at least partially supported by the secondary planar interface 137 which is then generally parallel to the underlying surface and is generally supported by the translation facilitating components 202.

The first supplementary component 113, as configured in FIG. 1, includes a continuous tread 140 which provides the first supplementary component 113 with capabilities of translating across underlying surfaces. The first framework coordinates 102 are substantially applicable to the second framework 142 as well with the provisos that the first framework coordinates 102 apply to the second framework 142 as they would when the first framework 114 and the second framework 142 are interconnected by the first framework latches 126 and the first supplementary component latches 128, respectively. A second framework 142 defines the structural basis for the first supplementary component 113. Interconnected with the second framework 142 are second framework cross-braces 144 spaced apart along the first framework first dimension 104. The second framework cross-braces 144 provide structural supports for the first framework 114 to rest upon, when interconnected with the second framework 142, and maintain the first framework 114, relative to the second framework 142, in a disposition that does not contact the continuous tread 140. In addition to said structural support, the second framework cross-braces 144 also provide sites for the first supplementary component latches 128 to have ready access to the first framework latches 126 when the first framework 114 is resting upon the first supplementary component 113. The continuous tread 140 has a semi-flexible construction that enables it to be pliant for ready bending about an axis disposed in the direction of the first framework second dimension 106. Interconnected with the second framework 142 and mostly disposed within the internal region of the second framework 142 are a plurality of continuous tread hubs 146 which are rotatable about the first framework second dimension 106. The continuous tread hubs 146 are disposed within the space defined by the continuous tread 140 to thereby enable the continuous tread 140 to revolve when the continuous tread hubs 146 rotate. Since the second framework cross-braces 144 allow the first conveyance constituent 112 to rest upon the first supplementary component 113 without contacting the continuous tread 140, so that the continuous tread 140 is free to revolve when the first flexibly configurable embodiment 110 is so configured. The revolving of the continuous tread 140 provides the first supplementary component 113 a translating capability, so that when the first conveyance constituent 112 is interconnected with the first supplementary component 113 it is also translatable by said revolving of the continuous tread 140, and hence an article being at least partially supported by the first conveyance constituent 112 is also thus translatable by the revolving of the continuous tread 140. As shown in FIG. 1, the continuous tread 140 comprises a looped band with a plurality of traction providing ribs 148. The translating capability of the first supplementary component 113 is also achievable in a variety of well known manners besides the looped and ribbed band, including, but not limited to, a looped but unribbed revolvable band; a plurality of rotatable wheels, rollers, casters, and analogous elements; skids, sleds, and other friction reducing mechanisms; ball bearings, and any other such mechanism that provides corresponding functionalities.

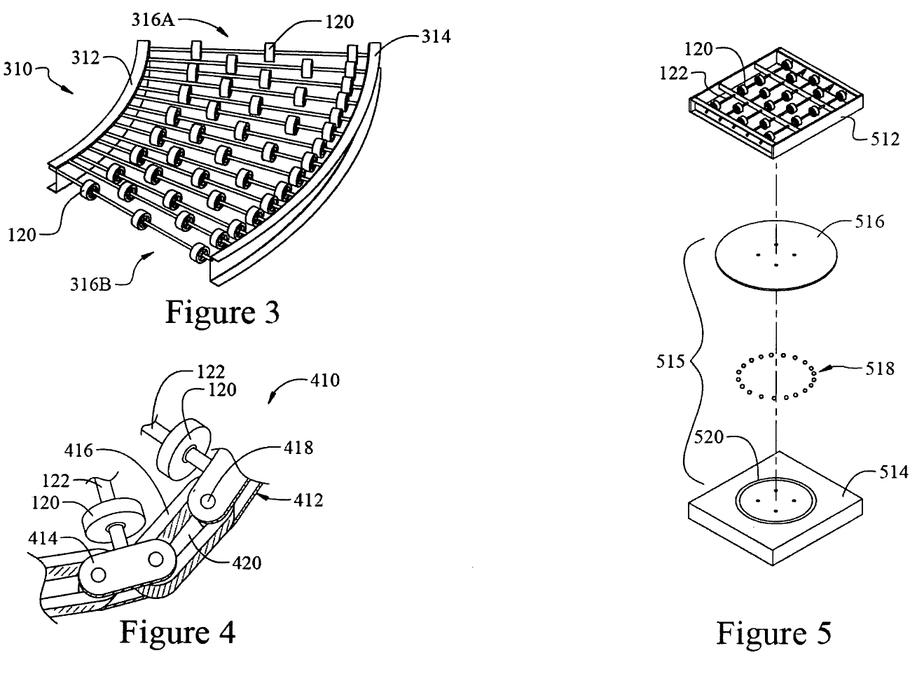

FIG. 3 depicts a first multidirectional conveyance path embodiment 310 which is capable of mitigating at least one gravitationally related article conveyance complication when at least partially supporting an article being conveyed along a curved conveyance path. The mechanical conveyance facilitators incorporated in the first multidirectional conveyance path embodiment 310 are depicted as comprising the rotatable wheels 120 of FIG. 1 for illustrative purposes only, and are not limiting of the variety of mechanical conveyance facilitators described herein, and their equivalents, that are utilizable. The first multidirectional conveyance path embodiment 310 is shown in FIG. 3 as defining a mitigably supported conveyance path that turns through an approximately 45 degree angle again for illustrative purposes only. The scope of present invention is not limited to these parameters alone and also encompasses alternative embodiments that incorporate variations in the turning angle magnitude, the number of and/or magnitude of changes in conveyance path curvature, as well as being capable of defining conveyance paths with alterable curvatures. In FIG. 3, the multidirectional conveyance path embodiment 310 has an inner lateral rail 312 and an outer lateral rail 314 whose curvatures are congruent with the inner lateral rail 312 having a greater radius of curvature than the outer lateral rail 314. The multidirectional conveyance path embodiment 310 is configured with symmetric conveyance path ends 316A and 316B so that a left turn can be effected by conveying the article from end 316B to 316A, and a right turn can be effected by conveying the article from end 316A to 316B. An additional spacer component (not shown) that is identical in outline to the multidirectional conveyance path embodiment 310 can be placed underneath the multidirectional conveyance path embodiment 310 in order to raise its height relative to the underlying surface to coincide with the combined height of the first conveyance constituent 112 and the first supplementary component 113, in addition to a variety of other well known ways to suitably raise the height of the multidirectional conveyance path embodiment 310.

FIG. 4 shows a lateral rail detail view of a second multidirectional conveyance path embodiment 410 that primarily differs from the first multidirectional conveyance path embodiment 310 by its articulating lateral rails 412 that are capable of varying the conveyance path they define. The particular physical realization of the articulating lateral rail 412 in FIG. 4 are depicted for illustrative purposes only, and are not limiting of the well-known variations that are capable of effecting corresponding functionalities to the functioning of the articulating lateral rail 412. One key function of the articulating lateral rail 412 is its capability to alter its curvature in either direction with alterably relatable pin lateral rail segments 414 and slot lateral rail segments 416. The articulating lateral rail 412 comprises alternating slot lateral rail segments 416 and pin lateral rail segments 414. The pin lateral rail segments 414 include a pin 418 that extends in said first framework third dimension 108 and that rides within a slot 420 formed within the slot lateral rail segments 416. The pins 418 are capable of both translating along the length of the slot 420, as well as rotating relative to the slot 420 which thereby enables adjacent pin lateral rail segments 414 and slot lateral rail segments 416 to both rotate and translate relative to each other. The second multidirectional conveyance path embodiment 410, by incorporating both types of lateral rail segments into both of its lateral rails, is capable of effecting conveyance path curving in both the left and right directions, and is further capable of effecting both types of curving with a single embodiment, if that embodiment is of sufficient length. When effecting a curve in a particular direction the pins 418 that both ride in a particular slot 420 will be relatively closer to each other when they are components of an inner curve forming lateral rail, and relatively farther from each other when they are components of an outer curve forming lateral rail. The second multidirectional conveyance path embodiment 410 can also be configured to enable mitigated conveying across uneven terrain. As shown in FIG. 4, the terminal ends of the slot lateral rail segments 416 are interleaved between first framework third dimension 108 positive and negative direction (also referred to as upper and lower, respectively, when applicable) sides of the terminal ends of the pin lateral rail segments 414. The space available for interleaving within the pin lateral rail segment 414 can be varied between a bare minimum gap required to receive the terminal end of the slot lateral rail segment 416, and an expanded gap that allows the slot lateral rail segment 416 to be disposed at a range of angles, relative to the pin lateral rail segment 414, in the plane defined by the first framework first dimension 104 and the third dimension 108. This flexibility of segment to segment angles of relative disposition enables the second multidirectional conveyance path embodiment 410 to be deployed in a terrain-hugging manner and thereby effect its conveying functions in situations that are otherwise not amenable to the deployment of a conveyance system.

An exploded view of third multidirectional conveyance path embodiment 510 is shown in FIG. 5. The third multidirectional conveyance path embodiment 510 includes a first spinable framework 512 that can spin relative to a first spinable-framework base 514 that it rests upon, said spinning occurring in the plane defined by the first framework first dimension 104 and the first framework second dimension 106. The first spinable framework 512 comprises mechanical conveyance facilitators such as the rotatable wheels 120 and is generally configured, with suitable alterations in the appropriate dimensions, similarly to the conveying mechanisms of many of the other embodiments of the present invention. It is further envisioned that the majority of the variations in mechanical conveyance facilitators, their interrelations with the various frameworks employed, and the suitable manners of varying the mechanical conveyance facilitators relative dispositions can also be utilized for configuring the first spinable framework 512 when suitable. The spinning capability is provided by a turntable assembly 515 intermediate the first spinable framework 512 and the first spinable-framework base 514. The turntable assembly 515 comprises a support plate 516, an array of ball-bearings 518, and a ball-bearing roller track 520 formed within the upper surface of the first spinable-framework base 514. The first spinable framework 512 is supported by (and usually attached to) the support plate 516, which in turn is supported by the array of ball-bearings 518, that are supported by, and constrained to roll within, the ball-bearing roller track 520. Generally, a second ball-bearing roller track (not shown) will also be formed into the underside of the support plate 516 to constrain the motion of the support plate 516 relative to the first spinable-framework base 514 (and therefore also constrain the relative motion of the first spinable framework 512) to being only capable of the spinning motion. The ball-bearings are utilized in well known ways to decrease the friction between the first spinable framework 512 and first spinable-framework base 514 and thereby enable their relative spinning to be readily effected. The scope of the present invention further encompasses a wide variety of mechanisms well-known to those of skill in the art that can also enable the desired spinning capability when operating intermediate the first spinable framework 512 and the first spinable-framework base 514. The particular details of the mechanism utilized to enable the relative spinning capabilities, separate from their combination with the other inventive aspects of the present invention, are not claimed subject matter herein, and accordingly any of a large variety of well-known mechanisms are also employable in the third multidirectional conveyance path embodiment 510.

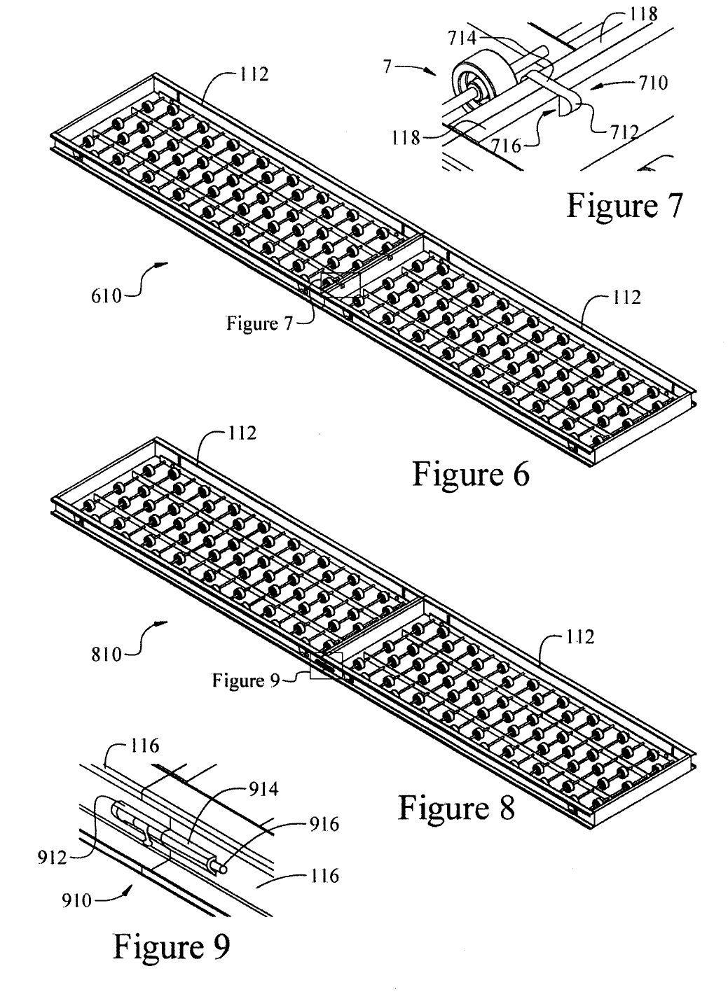

FIGS. 6-8 depict additional embodiments of the present invention that are both modularly combinable as well as examples of embodiments that present linking capabilities. The linkable embodiments enable the extension of conveying capabilities across more than one embodiment, as well as enabling the conveyance system to be effectively impromptuly deployable in situations where a single, unlinked embodiment is inadequate. The embodiment depictions shown in FIGS. 6-8 are generic representations of first frameworks and mechanical conveyance facilitators according to the present invention, and should be understood to not be limited to the particular conveyance system details depicted. Largely any of the conveyance system variations described herein are also combinable in linkable embodiments with suitable modifications, and the particular embodiments shown are merely illustrative and are chosen only for purposes of clarity of depiction of their linking capabilities. A first linkable embodiment 610 is shown in FIG. 6 in a linked state. The first linkable embodiment 610 is depicted as linking a pair of the first conveyance constituent 112 into a contiguous conveyance system of twice the length of a single first conveyance constituent 112. Square 7 indicates a region of the first linkable embodiment 610 that contains a first linkage 710; an expanded detail view of the area within dashed circle 7 is depicted in FIG. 7. The first linkage 710 comprises a pair of detents 712 spanned by a linkage body 714. The detents 712 restrict the relative separation of the linked first conveyance constituents 112 so that they are constrained to not being divided by a distance greater than the distance between detent internal faces 716. The first linkage 710 provides a readily employed linking capability (employment entailing only positioning the first linkage 710 in place as shown in FIGS. 6 and 7, and removal entailing only lifting it out of place) that can be configured to enable at least a partial degree of freedom in how the two linked first conveyance constituents 112 are dispositioned relative to each other. Among the partial degrees of freedom thus enabled are variability in the angles of inclination assumed by the two first conveyance constituents 112 when at least one detent internal face 716 is oriented at an angle greater than 90 degrees relative to the linkage body 714 so that the facing end rails 118 of each of the linked first conveyance constituents 112 are capable of assuming a range of angles relative to each other. Another of the partial degrees of freedom enabled involves the linkage body 714 extending a sufficient distance so that there is an amount of play between the linked first conveyance constituents 112.

FIG. 8 depicts a second linkable embodiment 810 that is also linking a pair of the first conveyance constituent 112 into a contiguous conveyance system of twice the length of a single first conveyance constituent 112. Though the depictions of both the first linkable embodiment 610 and the second linkable embodiment 810 show only two linked first conveyance constituents 112, it should be understood that the linkable embodiments of the present invention are not limited to linking only two conveying constituents such as the first conveyance constituent 112, and the number of the linked conveying constituents is not limited in principle, and will only be limited in practice by user specific constraints such as financial limitations, or deployment constraints such as a conveying situation that only has space, for example, for two linked conveying constituents. Square 9 indicates a region of the first linkable embodiment 810 that contains a second linkage 910; an expanded detail view of the area within dashed circle 9 is depicted in FIG. 9. Generally, the second linkage 910 will be affixed to the conveying constituents to be linked. By affixing, as opposed to the temporary placement of the first linkage 710, the second linkage 910 trades gains in structural strength for the cost of a more complicated mounting. A holding and locking guide 912 is affixed to one of the first conveyance constituents 112, and a receiving guide 914 is affixed to the other first conveyance constituent 112. A sliding bolt 916 is movable back and forth in holding and locking guide 912, and is insertable into receiving guide 914 in a standard form of bolt and sleeve arrangement. When the sliding bolt is inserted in receiving guide 914 it is then rotated about its longitudinal axis into a locking disposition to hold the two first conveyance constituents 112 into a substantially inflexible collinear relationship. To separate the two first conveyance constituents 112, the sliding bolt 916 is rotated away from its locking disposition and slid away from the receiving guide 914. Typically, there will be a pair of second linkages 910 on each end of each pair of lateral rails 116. Usually, one end of the first framework 114 will have a pair of holding and locking guides 914, and the other end will have a pair of the receiving guides 914, so that a plurality of first conveyance constituents 112 can be successively linked. The additional structural strength of the second linkage 910 enables the bridging of gaps two great for a single first conveyance constituent 112, when that first conveyance constituent 112 is configured of a particular size that is useful for ready portability, but is insufficient to bridge a gap greater than its length.

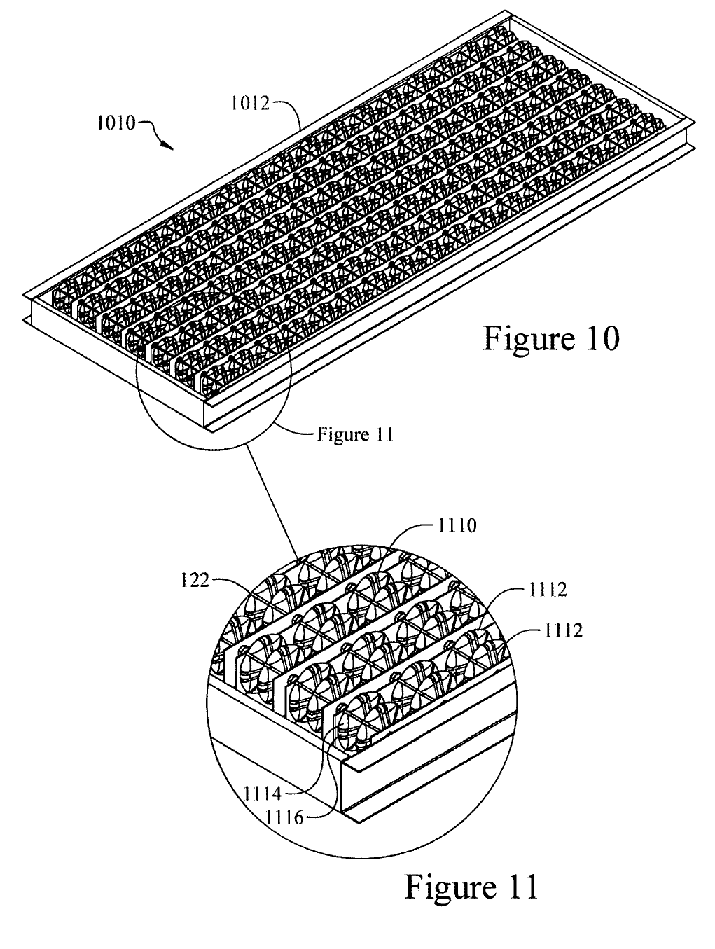

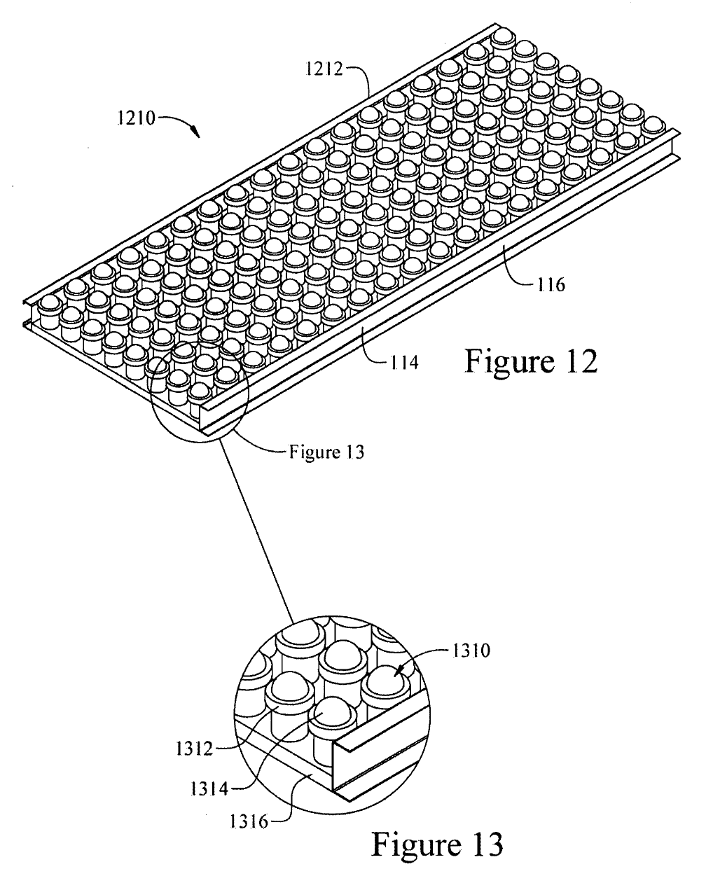

The embodiments described thus far utilize arrays of rotatable wheels 120 that are capable of facilitating conveyance in a direction that is perpendicular to their axes of rotation. Alternative embodiments of the present invention are capable of facilitating conveyance in more than one direction, without requiring the reorientation of the rotatable wheels' 120 axes, such as the third multidirectional conveyance path embodiment 510, nor by requiring that the rotatable wheels' 120 axes be arranged with a plurality of orientations such as the first multidirectional conveyance path embodiment 310. A fourth multidirectional conveyance path embodiment 1010 depicted in FIG. 10 comprises a second conveyance constituent 1012 that can also be modularly combinable and/or linkable analogously to the first conveyance constituent 112. The second conveyance constituent 1012 is configured with a plurality of bi-directional compound wheel assemblies 1110. Referring now to the FIG. 11 expanded detail view of the area within circle 11 of FIG. 10, a plurality of the bi-directional compound wheel assemblies 1110 are distributed across the planar extent of the second conveyance constituent 1012. The bi-directional compound wheel assemblies 1110 are arranged in rows, each row sharing one of the axles 122. Each of the bi-directional compound wheel assemblies 1110 is rotatable as a whole about the axles 122, and is thus capable of mitigating article conveyance in the direction of its overall rotation perpendicular to the axles 122 similarly to the action of the wheels 120. Multidirectional wheel assemblies are well known to those of ordinary skill in the art, and an example of such a wheel assembly similar to those employed in the fourth multidirectional conveyance path embodiment 1010 is commercially available from the McMaster-Carr Supply Company. This McMaster-Carr wheel assembly is termed: “Multidirectional Acetal—Dual wheel design has rollers that rotate around the wheel core . . . ” and can be found on page 1113 of the McMaster-Carr online catalog at the url: “http://www.mcmaster.com/” The bi-directional compound wheel assemblies 1110 comprise scaffold 1112 that is rotatable about axles 122, and which provides structural support for rotatable spindles 1114 and rotatable rings 1116 which both rotate about axes that are oriented at right angles to the axles 122. The rotatable spindles 1114 and rings 1116 are grouped into 4 combinations, each combination including two rotatable spindles 1114 and a single rotatable ring 1116 arranged so that the wide end of each rotatable spindle 1114 is adjacent the rotatable ring 1116. The four groupings are symmetrically distributed so as to encircle the axle 122, with the narrow end of a rotatable spindle 1114 of one group being adjacent the narrow end of a rotatable spindle 1114 of an adjacent group. The bi-directional compound wheel assemblies 1110 can hence rotate as a whole about axles 122 to facilitate article conveyance along the longitudinal direction of the fourth multidirectional conveyance path embodiment 1010, and the individual rotatable spindles 1114 and/or rotatable rings 1116 that are dispositioned for supporting an article can rotate about their individual axes to facilitate article conveyance in the transverse direction. The fourth multidirectional conveyance path embodiment 1010 can also facilitate conveyance in additional directions that are combinations of the longitudinal and transverse directions by mingling these two conveyance facilitation directions, but such a freely variable direction of conveyance facilitation will often be preferably realized with a fifth multidirectional conveyance path embodiment 1210 depicted in FIG. 12. The fifth multidirectional conveyance path embodiment 1210 comprises a third conveyance constituent 1212 that can also be modularly combinable and/or linkable analogously to the first conveyance constituent 112. In order to more clearly illustrate the composition of the third conveyance constituent 1212, it is shown without end rails 118, but in most realizations of the fifth multidirectional conveyance path embodiment 1210 the third conveyance constituent 1212 will comprise the first framework 114 including end rails 118 as shown in FIG. 1. An expanded detail view of the area within circle 13 is depicted in FIG. 13 which shows that the third conveyance constituent 1212 employs a plurality of ball transfer components 1310. Ball transfer components such as those shown in FIG. 13 are well known to those of ordinary skill in the art and are commercially available such as the examples illustrated on pages 1117-1119 in the McMaster-Carr online catalog. The schematic representations of ball transfer components 1310 in FIGS. 12 and 13 are generically describable as comprising a ball housing 1312 in which sits a freely rotatable ball 1314 that is supported by a plurality of smaller balls (not shown). The ball housings 1314 are distributed across an underlying plate 1316, although the third conveyance constituent 1212 can be alternatively configured with structural interconnections between adjacent ball housings 1314 (not shown) instead of the underlying plate 1316.

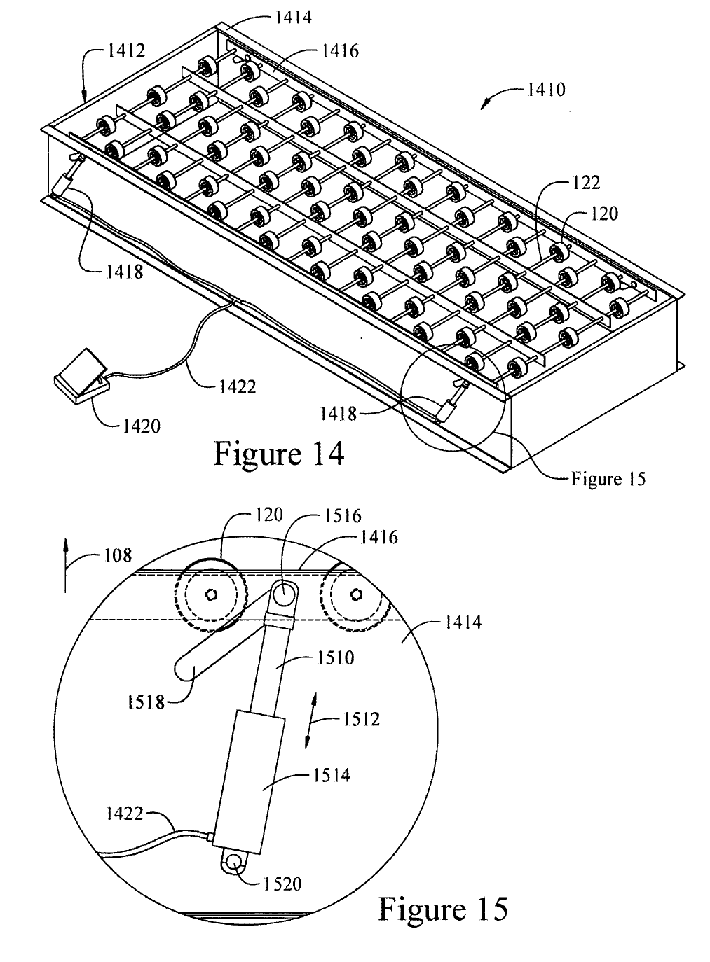

FIG. 14 depicts a first selectively facilitating embodiment 1410 that comprises a first selectively facilitating conveyance constituent 1412 that can also be modularly combinable and/or linkable analogously to the first conveyance constituent 112, and which is further capable of operating independently as are the other conveyance constituents described herein. The first selectively facilitating embodiment 1410 will be described in detail herein only as an independent apparatus, with the understanding that its structure and operational capabilities are just as applicable to modularly combined and/or linked embodiments as well. Additionally, the set of first framework coordinates 102 are also applicable with analogous relationships to the third framework 1414 and will hence also be used, when appropriate, in the description of the third framework 1414. The first selectively facilitating conveyance constituent 1412 comprises a third framework 1414 that includes at least one cardinal difference from said first framework 114. In the first conveyance constituent 112, the rotatable wheels 120 and the axles 122 are fixed in an immobile spatial disposition relative to the first framework 114. By contrast, in the third conveyance constituent 1212 the axles 122, and hence the rotatable wheels 120 also, are interconnected in an immobile spatial disposition with a first sub-framework 1416, and said first sub-framework 1416 has a selectively dispositionable interrelation with the third framework 1414. The disposition of the first sub-framework 1416 relative to the third framework 1414 is capable of shifting at least partially in the direction of the first framework third dimension 108 so that in at least a first disposition at least a portion of the rotatable wheels 120 extend past the third framework 1414 in the direction of the first framework third dimension 108, and in at least a second disposition they do not extend past the third framework 1414. The rotatable wheels 120 mitigability of at least one gravitationally related article conveyance complication is thus selectively effectible. An example of how this selective mitigability is an important utility can be demonstrated in regard to a combination of the third conveyance constituent 1212 with the first supplementary component 113. When conveying an especially heavy and bulky article, such as a multi-ton HVAC unit, from a delivery vehicle across undeveloped, unprepared ground with uneven terrain, the combination can be used by first disposing the rotatable wheels 120 beyond the third framework 1414 so that they can mitigate friction involved in loading the HVAC unit onto the third conveyance constituent 1212. Once loaded onto the third conveyance constituent 1212, the rotatable wheels 120 can then be repositioned in a disposition wherein they do not extend beyond the third framework 1414 and the loaded HVAC unit will be in a relatively stable disposition that is unlikely to easily change due to its weight induced static friction where it rests on the third framework 1414. The entire combined conveyance system can then be displaced by movement of the continuous tread 140 relative to the second framework 142 until the conveyance system and loaded HVAC unit are in the location desired. When in the desired location, the rotatable wheels 120 can then be repositioned again in a disposition wherein they do extend beyond the third framework 1414 so that the HVAC unit can then be effectively rolled off of the third framework 1414. Pneumatically adjustable struts 1418 in the general vicinities of the four corners of third framework 1414 provide the capabilities for repositioning the first sub-framework 1416 relative to the third framework 1414. A variety of well known means are utilizable for effecting the pneumatic pressurizing that produces said repositioning. As shown, a foot pump 1420 communicates pressurized air to the adjustable struts 1418 through hose 1422, but it should be understood that the foot pump 1420 and the arrangements of the hose 1422 are merely illustrative, and any arrangement of well known components can be utilized to provide the pressurized air that operates the pneumatically adjustable struts 1418. It should also be understood that the pneumatically adjustable struts 1418 could alternatively be configured as hydraulically operated struts (not shown). Numerous varieties of hydraulic struts are well known to those of ordinary skill in the art and can potentially provide greater load lifting power, at the cost of likely greater weight. The scope of the present invention encompasses both types of pressure driven struts as well as mechanical lifting apparatuses, an example of which is described later herein. An expanded detail view of the area within dashed circle 15 including the pneumatically adjustable strut 1418 is depicted in FIG. 15.

As shown in FIG. 15, the pneumatically adjustable struts 1418 comprises a pneumatic piston 1510 that rides back and forth in the direction 1512 within pneumatic cylinder 1514. The hose 1422 feeds pressurized air to an airtight chamber (not shown) within pneumatic cylinder 1514 that forces pneumatic piston 1510 out from pneumatic cylinder 1514 when the air pressure within the airtight chamber rises and allows the pneumatic piston 1510 to recede within pneumatic cylinder 1514 when the air pressure within the airtight chamber is reduced by action of any of a variety of well known means, such as a selectively operable check valve (not shown). The pneumatically adjustable struts 1418 is disposed outside of the third framework 1414, and it interconnects with the first sub-framework 1416 through a bearing 1516 in the vicinity of the distal end of the pneumatic piston 1510. A slot 1518 formed in a lateral side of the third framework 1414 receives passage therethrough and guides the motion of the bearing 1516. The bearing 1516, interconnected at an outer end with pneumatic piston 1510, also interconnects at an inner end with the first sub-framework 1416 so that when the pneumatic piston 1510 moves relative to pneumatic cylinder 1514, the bearing 1516 moves along slot 1518 and thereby repositions the first sub-framework 1416 at least partially in the first framework third dimension direction 108. Because the distal end of pneumatic cylinder 1514 is interconnected with third framework 1414 at bearing 1520, which enables the pneumatic cylinder 1514 to rotate but not displace relative to the third framework 1414, the movement of the bearing 1516 along slot 1518 repositions the first sub-framework 1416, relative to the third framework 1414, at least partially in the first framework third dimension direction 108. Changes in the pressurization of the air chamber within pneumatic cylinder 1514 are thus able to move the rotatable wheels 120 relative to the third framework 1414 so that when the pneumatic piston 1510 is sufficiently extended from the pneumatic cylinder 1514 the rotatable wheels 120 are exposed sufficiently that they can mitigate at least one gravitationally related article conveyance complication, and when the pneumatic piston 1510 is not sufficiently extended, the rotatable wheels 120 are not capable of so mitigating.

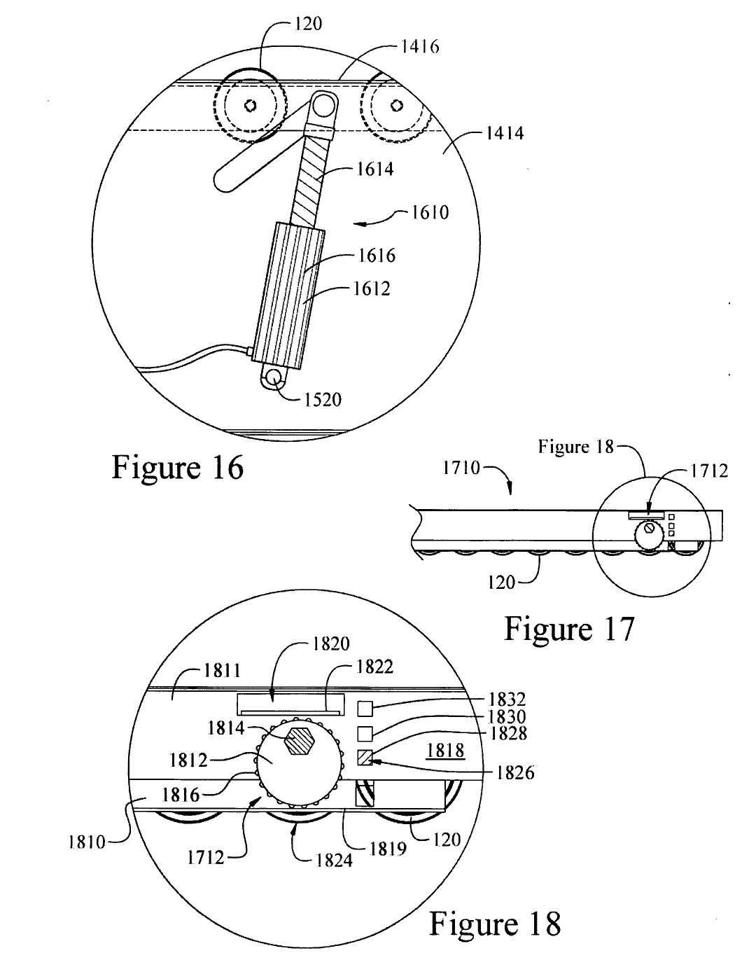

An alternative manner of providing the impetus to force a piston similar to pneumatic piston 1510 to move relative to a cylinder similar to pneumatic cylinder 1514 is shown in the illustration of mechanically adjustable strut 1610 in FIG. 16. The mechanically adjustable strut 1610 is utilizable in the same embodiments and in the same way as the pneumatically adjustable strut 1418. The principal difference from the pneumatically adjustable strut 1418, beyond the absence of the hose 1422 and the inflatable chamber within pneumatic cylinder 1514, is the switch of knurled cylinder 1612 for pneumatic cylinder 1514 and the switch of threaded piston 1614 for pneumatic piston 1510. The knurled cylinder 1612 has an outer surface 1616 formed into a plurality of longitudinal ridges to facilitate a hand grip for turning the knurled cylinder 1612 around its longitudinal axis. The knurled cylinder 1612 is internally spiral threaded in a pattern mated to an external spiral threading of the outer surface of threaded piston 1614. Turning the knurled cylinder 1612 in one direction will extend the threaded piston 1614 out from knurled cylinder 1612, and turning it in the other direction will retract the treaded piston 1614 into the knurled cylinder 1612, both of which will, in turn, effect the same selective dispositioning of the rotatable wheels 120 into or out of positions wherein they are capable of mitigating at least one gravitationally related article conveyance complication. The benefits of the mechanically adjustable strut 1610 include simplicity of construction; ease of use (which is not the same as ease of repositioning the rotatable wheels 120); and reliability of operation. Among the costs are the additional time required to adjust four mechanically adjustable struts 1610, one at each corner of the third framework 1414, in order to achieve an even set of rotatable wheels 120 dispositions (by contrast the pneumatically adjustable struts 1418 can all be configured to be adjusted by a single air pump); and a need for a potentially very large turning torque, in the case of exceptionally heavy articles being conveyed, that may be difficult to achieve by hand. It is possible to also configure the mechanically adjustable strut 1610 with additional mechanisms (not shown) such as a standard type of ratcheting attachment (that can be detachable as well) to speed the turning process and/or provide additional leveraging torque, and the third framework 1414 can even be configured with a mechanical torque transfer, such as intercommunicating driveshafts, so that a single ratchet attachment can effect adjustment of all four mechanically adjustable struts 1610 simultaneously and evenly.

Another alternative manner of effecting the selective repositioning of a sub-framework relative to a main framework is a second selectively facilitating embodiment 1710 shown in various partial views in FIGS. 17-19. FIG. 17 depicts a side-view of about one-third of a longitudinal end of the second selectively facilitating embodiment 1710. The sub-framework shown in FIGS. 17-19, termed a second sub-framework 1810, is closely related to the first sub-framework 1416. The main framework shown in FIGS. 17-19, termed a fourth framework 1811, is closely related to the third framework 1414. Inherent in the descriptions of the second selectively facilitating embodiment 1710, second sub-framework 1810, and the fourth framework 1811 is that, except for the differences identified, they are substantially comparable to the first selectively facilitating embodiment 1410, first sub-framework 1416, and third framework 1414, respectively. The area within dashed circle 18, including the eccentric cam assembly 1712, is depicted in an expanded detail view in FIG. 18 which more clearly shows the construction of the eccentric cam assembly 1712 and its interrelations to the rest of the conveyance constituent it is a part of. The eccentric cam assembly 1712 comprises a cam body 1812 which rotates about an axis centered in a hexagonal aperture 1814 that extends through the cam body 1812. The cam body 1812 can rotate relative to the fourth framework 1811 (via a circumferential rotatable bearing, not shown, of any of a variety of well known types that the hexagonal aperture 1814 passes through) but its rotational axis is fixed relative to the fourth framework 1811. A plurality of partially exposed, freely rotating ball bearings 1816 are arranged about the perimeter of cam body 1812. Alternatively, a freely rotating perimeter ring (not shown) can be substituted for the ball bearings 1816, as well as almost any of a number of well known manners of mitigating surface to surface friction, such as other rotating mechanisms or surface modifications, can also be substituted for the ball bearings 1816 and still remain within the scope of the present invention.

Fourth framework lateral side rail 1818, in addition to receiving passage therethrough of the circumferential rotatable bearing and hexagonal aperture 1814, also has additional apertures for passage therethrough that enable additional mechanical operations. When in the disposition shown in FIG. 18, the lowest of the ball bearings 1816 are supported by a second sub-framework lower flange 1819, and this support is translated to the fourth framework 1811 by the eccentric cam assembly 1712. An upper flange aperture 1820 provides an opening for a second sub-framework upper flange 1822 to project outward beyond the fourth framework lateral side rail 1818 sufficiently far in the second dimension direction 106 so that, when the eccentric cam assembly 1712 is rotated sufficiently far away from the lowest disposition shown in FIG. 18, the ball bearings 1816 will contact and then, with continued rotation, exert an upward force on the upper flange 1820. This eccentric cam assembly 1712 rotation can thereby lift upward (i.e. lift in the positive third dimension direction 108) the second sub-framework 1810 relative to the fourth framework 1811. Conversely, starting from when eccentric cam assembly 1712 is in a more elevated disposition (not shown) that is rotated 180 degrees about the hexagonal aperture 1814 from that shown in FIG. 18, a downward rotation of the eccentric cam assembly 1712 will lower the second sub-framework 1810 relative to the fourth framework 1811. The second sub-framework 1810 extends a lesser distance in the third dimension direction 108 than the diameter of the rotatable wheels 120, while the fourth framework 1811 extends a greater distance in the third dimension direction 108 than the rotatable wheels 120. A rotatable wheels perimeter 1824, whose axles 122 are interconnected with the second sub-framework 1810 approximately centered in its third dimension 108 direction, will extend beyond the limits of the second sub-framework 1810 in both the positive and the negative third dimension 108 directions. The diameter of the eccentric cam 1812, the degree of offset of its center of rotation from its geometrical center, and the relative sizings in the third dimension 108 direction of the fourth framework 1811 and the second sub-framework 1810 are configured so that:
1. When the eccentric cam 1812 is in the disposition shown in FIG. 18, termed a second sub-framework translating disposition, the rotatable wheels' perimeters 1824 are exposed beyond the fourth framework 1811 in the third dimension 108 negative direction;
2. When the eccentric cam 1812 is in a disposition (not shown) wherein it is rotated approximately 90 degrees clockwise from the disposition shown in FIG. 18, termed a second sub-framework inactive disposition, the rotatable wheels' perimeter 1824 will not be exposed beyond the fourth framework 1811 in either the positive or negative third dimension 108 directions; and
3. When the eccentric cam 1812 is in a disposition (not shown) wherein it is rotated approximately 180 degrees clockwise from the disposition shown in FIG. 18, termed a second sub-framework mitigating disposition, the rotatable wheels perimeter 1824 will be exposed beyond the fourth framework 1811 in the third dimension 108 positive direction.

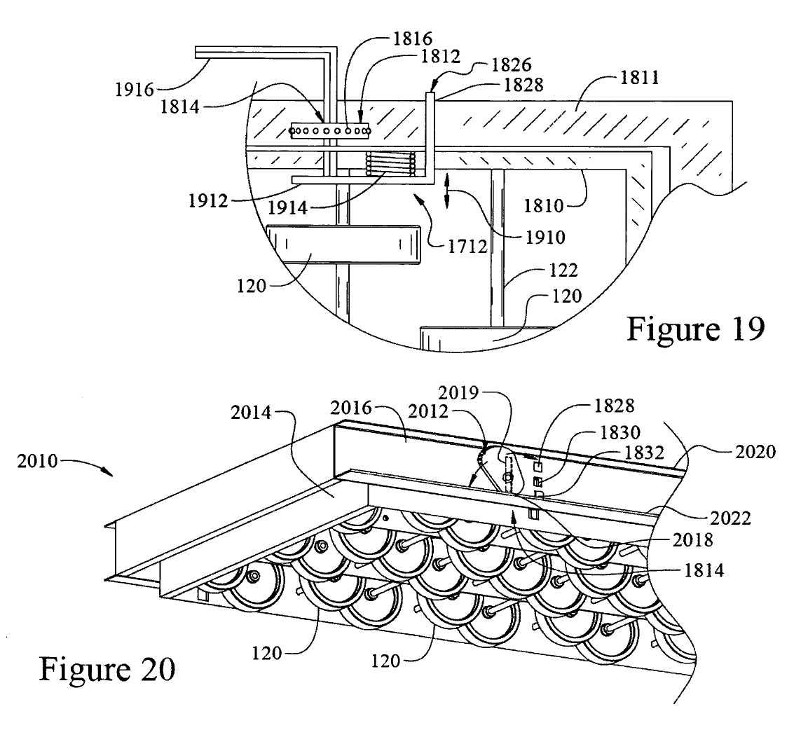

A second sub-framework disposition maintaining catch 1826 is a multiply disposable component of the eccentric cam assembly 1712. When the catch 1826 is inserted in translating disposition passage 1828, the second sub-framework 1810 is maintained in said translating disposition; when the catch 1826 is inserted in inactive disposition passage 1830, the second sub-framework 1810 is maintained in said inactive disposition; and when the catch 1826 is inserted in mitigating disposition passage 1832, the second sub-framework 1810 is maintained in said mitigating disposition. When the second sub-framework 1810 is in said translating disposition the rotatable wheels 120 are capable of facilitating translating the second selectively facilitating embodiment 1710 as a whole across an underlying surface; when the second sub-framework 1810 is in said mitigating disposition the rotatable wheels 120 are capable of mitigating at least one gravitationally related article conveyance complication involved in conveying at least one article with the second selectively facilitating embodiment 1710; and when the second sub-framework 1810 is in said inactive disposition the rotatable wheels 120 are maintained in a disposition wherein they are not generally capable of interacting with an underlying surface nor with an overlying article, so that their translating and mitigating capabilities are generally not active. As better shown in FIG. 19, which is a cross-section detail overhead view of the second selectively facilitating embodiment 1710, the catch 1826 moves back and forth in the direction 1910. Direction 1910 generally corresponds to movement in the direction of the second dimension 106, and the upward direction as depicted in FIG. 19 is elected to be the positive half of direction 1910. The catch 1826 is interconnected with a release plate 1912 that is in turn forced in the positive direction 1910 by restraining spring 1914 that is also interconnected with second sub-framework 1810. An Allen wrench 1916, when inserted sufficiently far through hexagonal aperture 1814, presses release plate 1912 in the negative direction 1910 until catch 1826 is moved far enough in the negative direction 1910 for catch 1826 to no longer be engaged in translating disposition passage 1828. Once the catch 1826 is no longer inserted in translating disposition passage 1828, the eccentric cam 1812 is then able to be rotated by the Allen wrench 1916. As the eccentric cam 1812 is rotated, the catch 1826 is successively lined up with inactive disposition passage 1830 and mitigating disposition passage 1832. Depending on the next desired operating mode of the second selectively facilitating embodiment 1710, the Allen wrench 1916 is removed from the hexagonal aperture 1814 when the catch is lined up with either the inactive disposition passage 1830 or the mitigating disposition passage 1832 to switch the second selectively facilitating embodiment 1710 from a translating mode depicted in FIGS. 18 & 19, to an inactive mode or a mitigating mode, respectively. Once the Allen wrench 1916 is removed from any of the passages, the release plate 1912 is no longer forced in the negative direction 1910 and the restraining spring 1914 will impel the catch 1826 in the positive direction 1910. When the catch 1826 is inserted in the translating disposition passage 1828, the second selectively facilitating embodiment 1710 is capable of utilizing the rotatable wheels 120 to facilitate translating the second selectively facilitating embodiment 1710 across an underlying surface. When the catch 1826 is inserted in the mitigating disposition passage 1832, the second selectively facilitating embodiment 1710 is capable of utilizing the rotatable wheels 120 to mitigate at least one gravitationally related article conveyance complication involved in conveying an article along a conveyance path. And when the catch 1826 is inserted in the inactive disposition passage 1830, the rotatable wheels 120 are in a disposition that renders them generally inactive for either translating or mitigating.

A third selectively facilitating embodiment 2010 is closely related to the second selectively facilitating embodiment 1710, differing primarily in the structure and manner of operation of the eccentric cam. An alternative eccentric cam 2012 is rotated in comparable fashion to eccentric cam 1812 by insertion of Allen wrench 1916 into hexagonal aperture 1814, and largely differs in construction by its unsymmetrical perimeter configuration, in contrast to the symmetrical perimeter configuration of eccentric cam 1812. A large variety of perimeter configurations for the eccentric cam are utilizable in various selectively facilitating embodiments, including utilization of the various friction-reducing approaches described previously, and the scope of the present invention encompasses all of these variations. The principal significant variation of the third selectively facilitating embodiment 2010 involves the manner in which the alternative eccentric cam 2012 effects the selective disposition of a third sub-framework 2014 relative to the fifth framework 2016. In the second selectively facilitating embodiment 1710 the rotational axis of the eccentric cam 1812 is positioned in a fixed relationship to the fourth framework 1811, and the second sub-framework 1810 is selectively repositionable relative to the eccentric cam 1812 rotational axis. Contrastingly, the rotational axis 2018 of the alternative eccentric cam 2012 is positioned in a fixed relationship to the third sub-framework 2014, and the fifth framework 2016 is selectively repositionable relative to the rotational axis of the alternative eccentric cam 2012. The motion of the third sub-framework 2014 relative to the fifth framework 2016 can be equivalently described in terms of the motion of the fifth framework 2016 relative to the third sub-framework 2014, with the appropriate description adjustments, and this equivalent approach with the third sub-framework 2014 and its fixed relationship to the rotational axis 2018 being the reference frame for describing the relative motion of the fifth framework 2016 will be utilized in the description of the third selectively facilitating embodiment 2010.

The general configuration of the alternative eccentric cam 2012 largely corresponds to that of the eccentric cam assembly 1712 with the primary differentiation involving the anchoring of the eccentric cam's rotational axis. The rotational axis of the eccentric cam assembly 1712 is anchored to the fourth framework 1811, and a slot (not shown) in the second sub-framework 1810 that extends in the direction of the third dimension 108 enables the rotational axis (and hexagonal aperture 1814) to move relative to the second sub-framework 1810. For the alternative eccentric cam 2012, the rotational axis 2018 of the alternative eccentric cam 2012 is anchored to the third sub-framework 2014, and a slot 2019 in the fifth framework 2016 that extends in the direction of the third dimension 108 enables the rotational axis 2018 (and hexagonal aperture 1814) to move relative to the fifth framework 2016. The fifth framework 2016 has laterally extending upper and lower flanges 2020 and 2022, respectively, that extend outward in the direction of the second dimension 106 sufficiently farther than the alternative eccentric cam 2012 so that when the alternative eccentric cam 2012 is rotated it will contact one of the flanges 2020 and 2022. As shown in FIG. 20, the alternative eccentric cam 2012 is rotated sufficiently far enough in the clockwise direction that it is in contact with upper flange 2020, and any further rotation will entail moving the fifth framework 2016, relative to the third sub-framework 2014, in the positive direction of the third dimension 108. The end positions of the alternative eccentric cam 2012 will be maintained by introduction of the catch 1826 into one of the mitigating disposition passage 1832, the inactive disposition passage 1830, and the translating disposition passage 1828. The unsymmetrical shape of the alternative eccentric cam 2012 enables it to effect greater movement of the fifth framework 2016 with lesser amounts of rotation of the alternative eccentric cam 2012, and also provides an inherent rotational limiting action, since the longer width of the alternative eccentric cam 2012 is greater than the separation of the upper and lower flanges 2020 and 2022, respectively. The operation of the third selectively facilitating embodiment 2010 is thus seen to be analogous to that of the second selectively facilitating embodiment 1710, with the distinction being in that the operating mode is determined by the relative disposition of the fifth framework 2016, rather than by the disposition of the third sub-framework 2014. In accordance with this distinction, the positions along the direction of the third dimension 108 of the mitigating disposition passage 1832 and the translating disposition passage 1828 are reversed from their relative positions in the second selectively facilitating embodiment 1710. When the fifth framework 2016 is maintained in a conveyance mitigating disposition the catch 1826 is inserted in the mitigating disposition passage 1832 so that the rotatable wheels 120 are exposed, in the positive direction of the third dimension 108, beyond the fifth framework 2016 and are hence available for mitigating at least one gravitationally related article conveyance complication. When the fifth framework 2016 is maintained in a translating disposition the catch 1826 is inserted in the translating disposition passage 1828 so that the rotatable wheels 120 are exposed, in the negative direction of the third dimension 108, beyond the fifth framework 2016 and are hence available for facilitating translating the third selectively facilitating embodiment 2010 across an underlying support surface. When the fifth framework 2016 is maintained in the inactive disposition, the catch 1826 is inserted in the inactive disposition passage 1830, and the rotatable wheels 120 are generally not capable of either mitigating or translating actions.

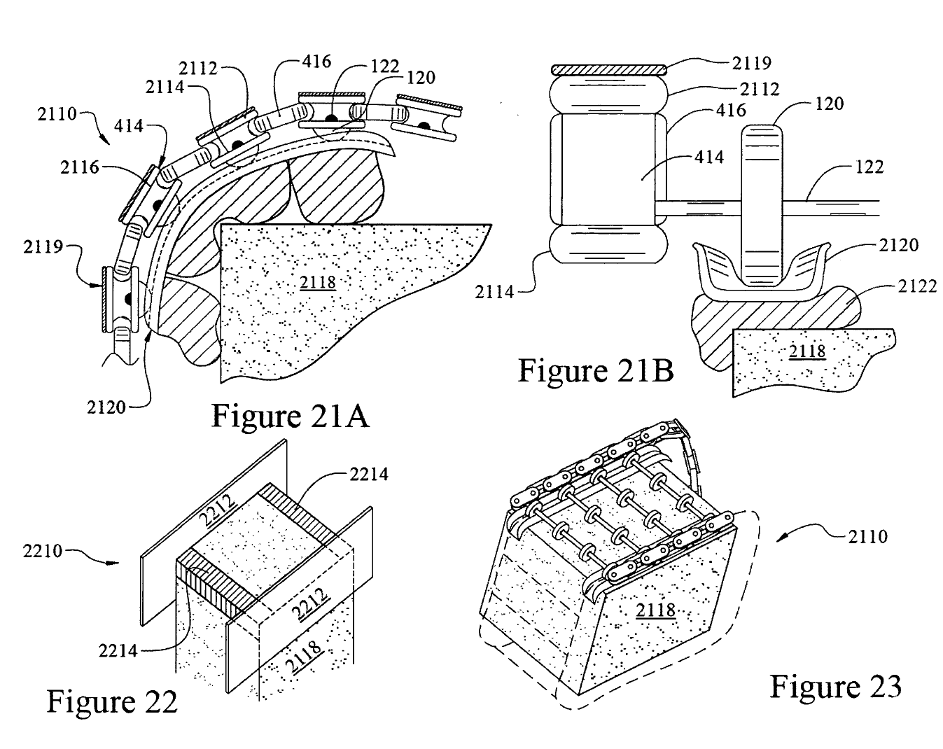

The articulating lateral rails 412, in addition to providing the second multidirectional conveyance path embodiment 410 with its capabilities of varying the defined conveyance path and of being capable of providing a topographic adaptability that enables said terrain hugging effect, can also be configured to provide an attaching/detaching capability wherein one of the slot lateral rail segments 416 is capable of being selectively attached to and detached from an adjacent one of the pin lateral rail segments 414. The manner of achieving this attaching/detaching effect can be as simple as configuring the pin 418 of the one slot lateral rail segment 416 to be selectively removable and selectively introducible, the introducing process including the appropriate placement of the pin lateral rail segment 414 such that when the pin 418 is reintroduced it also passes through the slot 420 of the one slot lateral rail segment 416. Numerous other manners of effecting this selective attaching/detaching are well known to those of ordinary skill in the art and are also encompassed by the scope of the present invention. An additional capability afforded by the articulating lateral rail 412 in combination with this selective attaching/detaching capability is the capacity to be self-attached so as to form an endless loop of articulating lateral rails 412. A circulating articulated lateral rail embodiment 2110, a partial detail side view of which is shown in FIG. 21A, utilizes self-attached articulating lateral rails 412, interrelated with mechanical conveyance facilitators such as rotatable wheels 120, that are arrangeable in a closed circuit about at least one article to be conveyed. It should be understood that there are also other forms of mechanical conveyance facilitator well known to those of ordinary skill in the art that are also readily utilizable in the various embodiments of the present invention, including the circulating articulated lateral rail embodiment 2110, such as revolving belts. As seen in FIG. 21A, the pin lateral rail segments 414 have first and second brims 2112 and 2114, respectively, that partially define a breach 2116 into which the end of the slot lateral rail segment 416 is nested for the insertion of the pin 418 through the pin lateral rail segment 414 and through the slot 420 to thereby effect the attaching of the slot lateral rail segment 416. The detaching involves simply the subsequent removal of the pin 418. The relative sizings of the breaches 2116, the slot lateral rail segments 416, the pins 418, and the slots 420, in addition to the relevant surface configurations, determine the available degrees of relative position alterability between one pin lateral rail segment 414 and the adjacent slot lateral rail segment 416. As is well known to those of skill in the art, the amount of play available determines the amount of relative position alterability.

In FIG. 21A, a view from the transverse direction to the conveying path, and FIG. 21B, a view from the general direction of the conveying path, a portion of a generic article 2118 to be conveyed is shown in part to illustrate a significant aspect of the operation of the circulating articulated lateral rail embodiment 2110. The generic article 2118 is shown as having a block shape in FIGS. 21-24 for clarity of illustration purposes only and it should be understood that the shape of the article that is conveyable with the circulating articulated lateral rail embodiment 2110 is essentially unlimited. A block shape is of particular use for illustration purposes because it is a form that is poorly suited for being moved by rolling or sliding, and hence its conveyance well demonstrates the benefits of the circulating articulated lateral rail embodiment 2110. An optional peripheral tread 2119 is configurable upon the exposed faces of the pin lateral rail segments 414 to provide a contact zone with an underlying surface without impacting the articulating operation of the articulating lateral rails 412. The peripheral treads 2119 can also be configured upon the slot lateral rail segments 416, although they will not always be as efficacious if so configured, since they will need to be configured so as to not limit the various degrees of play between the segments of the articulating lateral rails 412 more than desired, and because they would have to be constructed more thickly in order to extend as far as peripheral treads 2119 configured upon pin lateral rail segments 414. In certain deploying situations, and with certain articles being conveyed, it will be sufficient to merely deploy a closed circuit of the circulating articulated lateral rail embodiment 2110 about the article in order to begin conveying. Once the circulating articulated lateral rail embodiment 2110 is deployed about an article, the conveying merely entails impelling the article in the direction desired, and allowing the circulating articulated lateral rail embodiment 2110 to circulate about the article. When the circulating articulated lateral rail embodiment 2110 circulates about the article, it and the article roughly approximate an endless tread and tread support, wherein the tread support is the article being conveyed. The article is supported upon the segments of the articulating lateral rail 412 and interrelated rotatable wheels 120 that lie beneath the article; the article's conveyance across the segments of the articulating lateral rails 412 is facilitated by rotation of the rotatable wheels 120 it lies upon; and as the article is conveyed the circulating articulated lateral rail embodiment 2110 is circulated about the article by the article moving onto the next successive framework segments, while the framework segments it has moved off of are then pulled up and around the article until they are again eventually moved onto again by the article. In some cases, for example in order to help protect the article from any damaging effects of the movement of the circulating articulated lateral rail embodiment 2110 about it or in order to improve the ease or stability of circulation of the circulating articulated lateral rail embodiment 2110, articulating framework guides can be employed. A first articulating framework guide 2120 is shaped as a curved articulated framework trajectory guide that has a generally U-shaped cross-section which the rotatable wheels 120 travel within. The first articulating framework guide 2120 can be employed either just upon the top of the article 2118 being conveyed, or can be both above and below, or can be configured as an entire loop (not shown) about the article 2118. Many well known manners of conjoining the first articulating framework guide 2120 with the article 2118 are utilizable, and the examples shown are not intended to be limiting, but are chosen only for their illustrative advantages. In FIGS. 21 and 22, the manner of conjoining involves arranging pliable cushions 2122 in between the first articulating framework guide 2120 and the article 2118. The manner of construction of pliable cushions 2122 can range from bean bags to gel-filled envelopes to elastic putty, as well as many other well known forms. They can be deployed in an unfixed manner, when their positioning is not considered to be likely to shift, or they can be fixed to either the article 2118, such as through an adhesive or a mechanical means like straps, or they can be fixed to the first articulating framework guide 2120, or fixed to both. The articulating framework guide can also be configured as a more extensive guide than shown in FIGS. 21 and 22, and can be extended to encompassing the majority of, or even all of, the article 2118. Alternative manners of utilizing the circulating articulated lateral rail embodiment 2110 include utilizing guides that do not specifically direct the trajectory of the circulating articulated lateral rail embodiment 2110, but rather just constrain its trajectory to remain within a specified area. A second articulating framework guide 2210 shown in FIG. 22 is capable of effecting this trajectory constraining action by delimiting the available space for the articulating lateral rail 412 to pass through when circulating about the article 2118. The second articulating framework guide 2210 has a pair of constraining panels 2212 that are interconnected with a pair of panel connectors 2214. The panel connectors 2214 are shaped to fit around the upper corner edges of article 2118 and are generally positioned at the leading and trailing edges, relative to the intended conveyance path, of the article being conveyed. The panel connectors 2214 can be of a fixed configuration, when the form of the articles being conveyed is known and is repeatedly conveyed, or can be flexibly configurable to enable applicability to a variety of articles to be conveyed. The flexible configurability can involve only a telescoping capability, to be able to fit to similarly shaped, but differently sized articles; or can go as far as being highly plastic in both shape and size, such as when needed to convey articles that vary greatly in surface configuration and structural composition. The constraining panels 2212 are also capable of being configured in similarly widely varying ways. Among the benefits that are realizable by the constraining panels 2212 and the panel connectors 2214 are a controlling and stabilizing effect of the constraining panels 2212 on the articulating lateral rail 412 as it circulates about the article 2118 and protection of the article 2118 by the panel connectors 2212 as the articulating lateral rail 412 curves around the edges of the article 2118. The protective effect can be expanded by selectively increasing the area covered by the panel connectors 2214 (not shown), including expanding the area covered up to the point of mostly or even entirely covering the exposed surface of the article being conveyed. FIG. 23 illustrates an overall perspective view of the circulating articulated lateral rail embodiment 2110, without guides or other circulation aides, in situ when deployed about an article 2118 being conveyed.

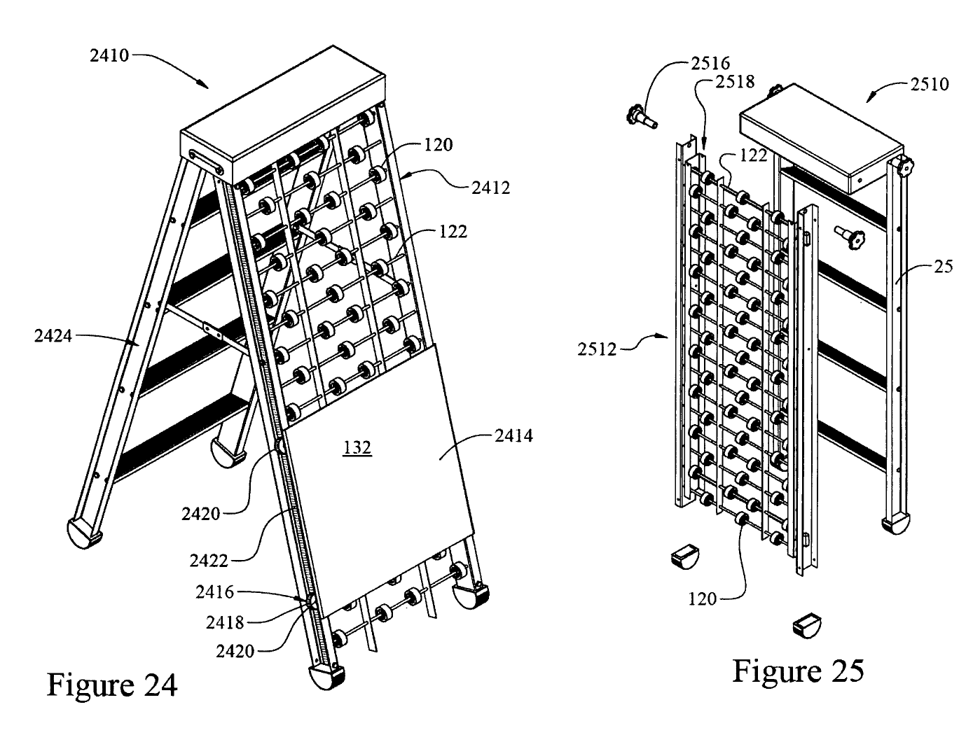

FIG. 24 shows a first composite conveying embodiment 2410 that combines a fourth conveyance constituent 2412 with a ladder component 2414. The fourth conveyance constituent 2412 largely corresponds to the first conveyance constituent 112, but differs primarily in its lacking the flexible configurability and modular constitutability of the first conveyance constituent 112. In accordance with its essentially permanent inclusion in the first composite conveying embodiment 2410, the fourth conveyance constituent 2412 also lacks the latches 126. The first composite conveying embodiment 2410 also comprises a second ancillary mechanical conveyance assistor 2414 that is also not detachable, in normal use, from the fourth conveyance constituent 2412. The second ancillary mechanical conveyance assistor 2414 includes the primary planar mechanical interface 132 but does not include the secondary planar interface 137, although the second ancillary mechanical conveyance assistor 2414 can be optionally also configured with the secondary planar interface 137 (not shown) when needed, but will generally not also be needed to be configured with the translation facilitating component 202 since it is generally not going to be detached from the first composite conveying embodiment 2410. A significant difference of the fourth conveyance constituent 2412 from the first conveyance constituent 112 is the inclusion of an ancillary mechanical conveyance assistor 2416. The ancillary mechanical conveyance assistor 2416 can take a wide variety of forms that are well known to those of ordinary skill in the art, and the particular example illustrated in FIG. 24 is chosen only for purposes of clarity of illustration and is not intended to be limiting of the varieties that fall within the scope of the present invention. The exemplary ancillary mechanical conveyance assistor 2416 illustrated in FIG. 24 comprises a toothed gear 2418 that revolves around a gear axle 2420 that is fixedly interconnected with the second ancillary mechanical conveyance assistor 2414. As shown in FIG. 24, the first composite conveying embodiment 2410 is configured with an optional pair of ancillary mechanical conveyance assistors 2416, to provide options of effecting more assistance than available with a single ancillary mechanical conveyance assistor 2416. The ancillary mechanical conveyance assistor 2416 is also generally turned by way of the Allen wrench 1916 that is fitted into a hexagonal aperture in the gear axle 2420, though a wide variety of other well known means, including manual as well as powered means, are also within the scope of the present invention. The toothed gear 2418 operates in cooperation with a plurality of grooves 2422 formed into the fourth conveyance constituent 2412, and effects its assisting action by exerting force against the grooves 2422 when the toothed gear 2418 is rotated. The first composite conveying embodiment 2410 includes a ladder constituent 2424 that is interconnected with the fourth conveyance constituent 2412, although a wide variety of alternative constituents also fall within the scope of the present invention. As shown in FIG. 24, the first composite conveying embodiment 2410 is disposed as a step ladder, wherein the fourth conveyance constituent 2412 and the ladder constituent 2424 are arranged at their maximum separation for stability of ladder function. When used as a conveyance system, the ladder constituent 2424 will generally be disposed at its minimum separation from the fourth conveyance constituent 2412, and can provide additional structural support for the conveyance of an article.

In FIG. 25, a second flexibly configurable embodiment 2510 is shown in a partially exploded view. The second flexibly configurable embodiment 2510 also can be characterized as both another modular embodiment as well as another composite embodiment of the present invention. The second flexibly configurable embodiment 2510 comprises a fifth conveyance constituent 2512 and a detachable ladder constituent 2514. The detachable ladder constituent 2514 is selectively interconnected with the fifth conveyance constituent 2512 with screw fasteners 2516. A significant aspect of the fifth conveyance constituent 2512 is a selective braking bar 2518 that, when pressed into forceful contact with the axles 122, is capable of modulating the rate of conveyance of an article whose conveyance is being facilitated by the rotatable wheels 120 by impeding their rotation. This rate modulating effect can be of particular utility when conveying an especially heavy article form a higher to a lower elevation, and there is hence an inherent risk of the conveying process being driven out of safe control by gravity. A sizeable multitude of well known forms of conveyance assisting and conveyance rate modulating are also utilizable with virtually any of the embodiments of the present invention. These forms of assisting and modulating are also combinable within the same embodiment, for example by utilizing the selective braking bar 2518 in concert with the ancillary mechanical conveyance assistor 2416. Additionally, the ancillary mechanical conveyance assistor 2416 can also be configured to act as a conveyance rate modulator as well, by adding an adjustable friction-inducing element (not shown) to the gear axle 2420. This frictional element can be a selectively restrictable collar about the gear axle 2420 that can be loosened enough to not affect the rotation of the gear axle 2420, or can be tightened so as to exert a frictional force that impedes the rotation of the gear axle 2420 sufficiently to slow or even stop its rate of rotation. Additional methods of providing conveyance assistance, for example when attempting to convey a weighty article from a lower to a higher elevation, can include those that are manually powered as well as those that utilize various forms of supplied power, such as electric, hydraulic, and pneumatic forms in addition to mechanical types. Well known examples of these include substituting a screw jack (not shown), or a winch (also not shown) for the ancillary mechanical conveyance assistor 2416.

In view of the above, it will be seen that the various objects and features of the invention are achieved and other advantageous results obtained. The examples contained herein are merely illustrative and are not intended in a limiting sense.

What is claimed is:

1. An impromptuly deployable article conveyance system comprising:
at least one mechanical conveyance facilitator interrelated with a first framework, said first framework having at least three non-collinear base points capable of collectively bearing said first framework in a stable conveying disposition;
at least partial support providable by said first framework for at least one article being conveyed on a conveyance path and at least one gravitationally related article conveyance complication mitigable by said first mechanical conveyance facilitators when a supporting portion of said first framework first dimension is disposed at least partially along at least one supported conveyance path section;
wherein, for deployment situations encompassing a suitable conveyance path between first and second settings capable of bearing the article, said settings and conveyance path potentially differing for each deployment situation, said conveyance system is impromptuly deployable with said first framework first dimension disposed at least partially along at least a portion of said conveyance path and is promptly operable upon deployment in said stable conveying disposition.

2. The impromptuly deployable article conveyance system according to claim 1, wherein said conveyance system is portable when in an operable condition.

3. The impromptuly deployable article conveyance system according to claim 1, wherein said conveyance system is flexibly configurable when in an operable condition, said flexible configurability including at least one of,
a) variability of the constituent contents of said conveyance system; and
b) alterability of the arrangements of said conveyance system's constituents.

4. The impromptuly deployable article conveyance system according to claim 1, wherein said first framework's support for conveyed articles is at least one of direct and indirect, and at least one gravitationally related article conveyance complication is mitigable by said mechanical conveyance facilitators, said gravitationally related article conveyance complication involving at least one article attribute selected from a group consisting of:
a) said articles' weight;
b) said articles' balance;
c) said articles' dispositional management;
d) said articles' orientation requirements;
e) said article's vulnerability to conveyance related effects upon said articles' condition;
f) and combinations thereof.

5. The impromptuly deployable article conveyance system according to claim 1, wherein said mechanical conveyance facilitators' are moveable relative to at least one portion of the first framework, said mechanical conveyance facilitator movement contributing to said gravitationally related article conveyance complication mitigability;
said system optionally further comprising at least one conveying process influencing mechanism, said conveying process influencing mechanism providing at least one effect chosen from a group consisting of:
a) at least partially affecting a rate of conveying of at least a portion of the conveying process;
b) at least partially enhancing a rate of conveying of at least a portion of the conveying process;
c) at least partially governing a rate of conveying of at least a portion of the conveying process;
d) at least partially affecting at least one dynamic parameter of at least a portion of the conveying process;
e) at least partially offsetting at least one dynamic complication of at least a portion of the conveying process;
f) at least partially governing at least one dynamic parameter of at least a portion of the conveying process;
g) and combinations thereof.

6. The impromptuly deployable article conveyance system according to claim 5, wherein at least one of said mechanical conveyance facilitators is rotatable about an axis that is constrainable relative to said first framework, at least a portion of said first framework's article support being imparted to said articles through said rotatable conveyance facilitators, and said gravitationally related article conveyance complications are at least partially mitigable by rotation of at least one of said rotatable conveyance facilitators.

7. The impromptuly deployable article conveyance system according to claim 6, wherein the rotation of at least one of said rotatable conveyance facilitators is controllable and operation of at least one of said rotation and rotation control is at least one of selective, passive, automatically responsive to a conveyance related factor, consistent for all of said conveyance system's rotatable conveyance facilitators, and variable for differing subsets of said conveyance system's rotatable conveyance facilitators.

8. The impromptuly deployable article conveyance system according to claim 6, wherein said rotatable conveyance facilitators' rotational axes are selectively dispositionable, relative to said first framework, so that said rotational axes' selective dispositioning contributes to determining at least one direction of article conveying that said rotatable conveyance facilitators can more effectively mitigate at least one of said gravitationally related article conveyance complications.

9. The impromptuly deployable article conveyance system according to claim 6, wherein at least one of said rotatable conveyance facilitators is variably dispositionable, said varying dispositions capable of providing varying degrees of mitigability of said gravitationally related article conveyance complications.

10. The impromptuly deployable article conveyance system according to claim 9, said first framework extending at least a minimum depth of a first framework third dimension that is perpendicular to said first framework first dimension, said portion of said first framework's article support being imparted through said mechanical conveyance facilitators being at least partially imparted through at least a first set of said rotatable conveyance facilitators that can vary dispositions by translating in the direction of said first framework third dimension, said translating capable of varying said first set's degree of mitigability sufficiently to suppress said mitigability.

11. The impromptuly deployable article conveyance system according to claim 10, wherein said first set of variably dispositionable rotatable conveyance facilitators are translatable at least partially in the direction of said first framework third dimension between a first active and a second inactive extremum, such that said first set are able to mitigate at least one of said gravitationally related article conveyance complications when at said first active extremum and are not able to so mitigate when at said second inactive extremum.

12. The impromptuly deployable article conveyance system according to claim 10 further characterized by having first framework third dimension first and second sides separated by at least said minimum depth, by said first set having at least one operative face for applying said mitigability, and by said first set being translatable in the direction of said first framework third dimension between first side and second side extremums, wherein:
a) when said first set is disposed at said first side extremum, said operative faces are disposed, relative to said third dimension first side, so that said gravitationally related article conveyance complication mitigability is functional, and
b) when said first set is disposed at said second side extremum, said operative faces are disposed, relative to said third dimension second side, so that they are capable of mitigating at least one gravitationally related conveyance system displacement complication.

13. The impromptuly deployable article conveyance system according to claim 11, further comprising at least a second set of variably dispositionable rotatable conveyance facilitators that are translatable at least partially in the direction of said first framework third dimension between third inactive and fourth active extremums, such that said second set are able to mitigate at least one gravitationally related conveyance system displacement complication when at said fourth active extremum and are not able to so mitigate when at said third inactive extremum.

14. The impromptuly deployable article conveyance system according to claim 1, said conveyance system further comprising at least one auxiliary conveying functionality selected from a group consisting of:
a) a selectively operable conveying process modulator capable of influencing at least one operative parameter of said conveying process;
b) an autonomously operable conveying process modulator capable of influencing at least one operative parameter of said conveying process, said autonomous operation occurring in response to at least one of said operative parameters;
c) a selectively operable conveying process arrestor capable of at least partially impeding at least one portion of said conveying process;
d) an autonomously operable conveying process arrestor capable of at least partially impeding at least one portion of said conveying process, said autonomous operation occurring in response to at least one conveying process condition;
e) a selectively operable conveying process augmentor capable of at least partially assisting at least one portion of said conveying process;
f) an autonomously operable conveying process augmentor capable of at least partially assisting at least one portion of said conveying process, said autonomous operation occurring in response to at least one conveying process condition;
g) and combinations thereof.

15. The impromptuly deployable article conveyance system according to claim 1 further comprising at least one ancillary mechanical conveyance assistor capable of mechanically assisting said mitigation of at least one gravitationally related article conveyance complication, said mechanical assisting involving at least one of,
a) augmenting said mechanical conveyance assistors' mitigation of at least one gravitationally related article conveyance complication, and
b) acting separately from said mechanical conveyance facilitators by providing ancillary mitigation of at least one gravitationally related article conveyance complication.

16. The impromptuly deployable article conveyance system according to claim 15, said ancillary mechanical conveyance assistor providing a mechanical interface suitable for communicating at least one of said conveyance system's conveyance facilitation support and to the articles being conveyed, said interface being movable in concert with the articles being conveyed, said concerted movement of the interface and articles being conveyed providing capabilities for at least one of said mechanical conveyance facilitators to facilitate said conveyance without directly contacting said article.

17. The impromptuly deployable article conveyance system according to claim 16, wherein said mechanical interface comprises at least one component selected from a group consisting of:
a) a conduit;
b) a vessel;
c) a container;
d) a tray;
e) a plate;
f) a rack;
g) a frame;
h) a bracket;
i) a drawer;
j) a strap;
k) a cable;
l) a receptacle;
m) a chassis;
n) an armature;
o) a carton;
p) a basket;
q) a casing;
r) a box;
s) a wrapper;
t) a cover;
u) a hook;
v) a clamp;
w) a fastener;
x) a support plate;
y) a shelf;
z) a pallet;
aa) a webbing;
bb) a bin;
cc) a bag;
dd) a capsule;
ee) a jacket;
ff) a chamber;
gg) and combinations thereof.

18. The impromptuly deployable article conveyance system according to claim 16, wherein said ancillary mechanical conveyance assistor is at least partially separable from the balance of said conveyance system, said separability enabling said ancillary mechanical conveyance assistor to provide at least one capability selected from a group consisting of:
a) suitability, when in an at least partially separated state, for interfacing with at least one article;
b) suitability, when in an at least partially separated state, for aiding in translating at least one article;
c) suitability, when in an at least partially separated state, for aiding in controlling at least one article;
d) suitability, when in an at least partially separated state, for aiding initiation of at least partial support of at least one article by the balance of said conveyance system;
e) suitability, when in an at least partially separated state, for aiding conclusion of at least partial support of at least one article by the balance of said conveyance system;
f) and combinations thereof.

19. The impromptuly deployable article conveyance system according to claim 1, further comprising at least one transporter component through which said conveyance system is readily transportable so that the conveyance system is capable of effecting said article conveying both by translating at least one of said articles relative to the conveyance system, and by transporting said conveyance system when it is at least partially supporting at least one of said articles.

20. The impromptuly deployable article conveyance system according to claim 1, wherein at least a portion of said first framework is selectively reorientable, without need for reorienting the balance of said conveyance system, so that at least one portion of said conveying path is modifiable by said first framework portion's reorienting.

21. The impromptuly deployable article conveyance system according to claim 1, wherein said conveyance systems are linkable so that an extended conveyance path is definable by a plurality of said linked conveyance systems.

22. The impromptuly deployable article conveyance system according to claim 1, wherein said conveyance system is configurable with at least a portion of

23. The impromptuly deployable article conveyance system according to claim 1, further comprising at least one supplementary component that is capable of at least one non-conveying function, wherein at least one of said supplementary components and non-conveying functions is selected from a group consisting of:
a) a ladder;
b) an implement securing assembly;
c) a workbench;
d) a work-object securing apparatus;
e) a work-surface;
f) a vise;
g) a toolbox;
h) a filing implement;
i) a sanding implement;
j) a scoring device;
k) a metal-working implement;
l) a wood-working implement;
m) a stone-working implement;
n) a plastic-working implement;
o) a material-working implement;
p) a lighting source;
q) a fastening implement;
r) a cutting implement;
s) a joining implement;
t) an assembling implement;
u) a testing implement;
v) a ruler;
w) a scale;
x) a measuring implement;
y) a storage container;
z) a floatation device;
aa) and combinations thereof.

24. The impromptuly deployable article conveyance system according to claim 23, wherein said supplementary component is at least partially separable from the balance of said conveyance system.

25. The impromptuly deployable article conveyance system according to claim 3, wherein said flexible configurability is effectible by said conveyance system being constitutable from modular constituents.

26. The impromptuly deployable article conveyance system according to claim 25, wherein said flexible configurability includes at least said constituent variability, said modular constitutability generally involving detachable interconnections between said first framework and at least one additional modular constituent, said detachable interconnections being at least one of direct and indirect, said modular constituents being selected from a group consisting of:
a) a second framework;
b) at least one supplementary component that is capable of at least one non-conveying function;
c) at least one complementary mechanical conveyance facilitator;
d) at least one mechanical conveyance system transporter component;
e) at least one specialized conveying implement that is particularly suitable for conveying at least one specific type of article;
f) at least one conveying process modulator;
g) at least one ancillary mechanical conveyance assistor;
h) at least one auxiliary conveying functionality;
i) and combinations thereof.

27. An impromptuly deployable method of conveying at least one article comprising the steps of:
deploying a conveyance system in an impromptu manner,
said conveyance system comprising at least one mechanical conveyance facilitator interrelated with a first framework, said first framework having at least three non-collinear base points capable of collectively bearing said first framework in a stable conveying disposition,
said deploying entailing disposing said conveyance system in said stable conveyance disposition with at least one supporting portion of said first framework first dimension disposed at least partially along at least one supported section of a conveyance path between first and second settings, said conveyance system being essentially immediately operable upon said disposing in said stable conveying disposition,
said deploying manifesting said impromptu manner by substantially only entailing preliminarily ascertaining that deploying situations include at least one suitable conveyance path between first and second settings capable of bearing the articles to be conveyed, said settings, stable conveying disposition, and conveyance path being widely variable for differing deploying situations;
providing at least partial support for at least one article being conveyed along at least one of said conveyance path supported sections; and
facilitating said conveying by mitigating at least one gravitationally related article conveying complication with at least one of said mechanical conveyance facilitators when providing said at least partial support for at least one article being conveyed

28. The impromptuly deployable method of conveying at least one article according to claim 27, further comprising the step of providing a conveyance system capable of realizing said method.

29. The impromptuly deployable method of conveying at least one article according to claim 27, wherein said conveyance system is reconfigurable, when in an operable condition, said method further comprising an optional step of reconfiguring said conveyance system by effecting at least one of:
a) varying the constituent contents of said conveyance system; and
b) altering the arrangement of said conveyance system's constituents.

30. The impromptuly deployable method of conveying at least one article according to claim 27, wherein said mitigating involves at least one of said mechanical conveyance facilitators moving relative to said first framework and said conveyance system optionally further comprises at least one conveying process influencing mechanism, said method further comprising an optional step of utilizing said conveying influencing mechanism to provide at least one effect chosen from a group consisting of:
a) at least partially affecting a rate of conveying of at least a portion of the conveying process;
b) at least partially enhancing a rate of conveying of at least a portion of the conveying process;
c) at least partially governing a rate of conveying of at least a portion of the conveying process;
d) at least partially affecting at least one dynamic parameter of at least a portion of the conveying process;
e) at least partially offsetting at least one dynamic complication of at least a portion of the conveying process;
f) at least partially governing at least one dynamic parameter of at least a portion of the conveying process;
g) and combinations thereof.

31. The impromptuly deployable method of conveying at least one article according to claim 30, wherein said moving mechanical conveyance facilitators are rotatable about axes that are constrainable relative to said first framework, said mitigating involving rotation of at least one of said moving mechanical conveyance facilitators, said method further comprising the step of governing said mechanical conveyance facilitators' rotating, said governing having at least one attribute selected from a group consisting of:
a) operating passively;
b) operating selectively;
c) operating automatically in response to a conveyance related factor;
d) operating consistently for all of said conveyance system's rotatable conveyance facilitators;
e) operating differently for differing subsets of said conveyance system's rotatable conveyance facilitators;
f) providing a conveyance system capable of realizing at least one of the present claim 31 further steps a) through e);
g) and combinations thereof.

32. The impromptuly deployable method of conveying at least one article according to claim 30, wherein said moving mechanical conveyance facilitators are rotatable about axes that are constrainable relative to said first framework, said mitigating involving rotation of at least one of said moving mechanical conveyance facilitators, and at least one of said rotatable mechanical conveyance facilitators' axes are variably dispositionable relative to said first framework, said axes' variable dispositions contributing to determining at least one article conveying direction in which the mechanical conveyance facilitators can more effectively mitigate at least one of said gravitationally related article conveying complications, said method further comprising the step of securing at least one of said variably dispositionable axes in a disposition that establishes at least one of said more effectively mitigated article conveying directions.

33. The impromptuly deployable method of conveying at least one article according to claim 30, wherein at least one of said moving mechanical conveyance facilitators is rotatable about an axis that is constrainable relative to said first framework, said mitigating involving rotation of at least one of said moving mechanical conveyance facilitators, at least one of said rotatable conveyance facilitators being variably dispositionable, said varying dispositions providing varying degrees of mitigability of said gravitationally related article conveying complications, said method further comprising the step of disposing at least one of said variably dispositionable rotatable conveyance facilitators so as to realize at least one of said degrees of article conveying mitigability.

34. The impromptuly deployable method of conveying at least one article according to claim 33, further comprising the step of varying the degree of article conveying mitigability by translating at least one of said variably dispositionable rotatable conveyance facilitators along a first framework third dimension that is not parallel to said first framework first dimension, said conveyed article support acting at least partially in the direction of said first framework third dimension, said third dimension translating step including at least one further effect selected from a group consisting of:
a) suppressing said mitigability by translating at least one of said variably dispositionable rotatable conveyance facilitators into at least one third dimension inoperative position;
b) expressing said mitigability by translating at least one of said variably dispositionable rotatable conveyance facilitators into at least one third dimension operative position;
c) modulating said mitigability by translating at least one of said variably dispositionable rotatable conveyance facilitators into at least one third dimension modulating position wherein their rotational freedom is at least partially repressed;
d) and combinations thereof.

35. The impromptuly deployable method of conveying at least one article according to claim 33, wherein at least a portion of said support for an article being conveyed is expressible at least one of directly and indirectly via at least one operative face of at least one of said variably dispositionable rotatable conveyance facilitators so that said mitigability is at least partially effectible by rotating at least one of said support expressing operative faces, said varying dispositions capable of varying the expressibility of at least one of said operative faces' article conveying mitigability by varying the expressibility of said operative faces' support for at least one article being conveyed, further comprising the step of:
selectively expressing at least one of said operative faces' article conveying mitigability by selectively expressing said at least one operative face's support for an article being conveyed.

36. The impromptuly deployable method of conveying at least one article according to claim 35, said first framework further having a first framework third dimension that is not parallel to said first framework first dimension, at least a portion of said article conveying support being at least partially expressible in a positive direction of said first framework third dimension, further comprising at least one step selected from a group consisting of:
a) expressing at least one of said operative faces' supportability for an article being conveyed by translating said operative face in the first framework third dimension positive direction;
b) expressing at least one of said operative faces' article conveying mitigability by translating said operative face in the first framework third dimension positive direction;
c) repressing at least one of said operative faces' supportability for an article being conveyed by translating said operative face in a first framework third dimension negative direction;
d) repressing at least one of said operative faces' article conveying mitigability by translating said operative face in a first framework third dimension negative direction;
e) providing a conveyance system capable of realizing at least one of the present claim 36 further steps a) through d);
f) and combinations thereof.

37. The impromptuly deployable method of conveying at least one article according to claim 35, said first framework further comprising a first framework third dimension that is not parallel to said first framework first dimension and being upheld, when in a stable conveying disposition, by at least one bearing force acting at least partially in said first framework third dimension positive direction;
wherein at least one of said variably dispositionable rotatable conveyance facilitators is at least partially translatable in a first framework third dimension negative direction so that at least a portion of its operative face is disposable below at least one of said base points, said operative face, when disposed below at least one of said base points, being capable of at least one of:
a) at least partially bearing said first framework;
b) at least partially mitigating at least one gravitationally related conveyance system displacing complication; and
c) combinations thereof.

38. The impromptuly deployable method of conveying at least one article according to claim 37, further comprising at least one step selected from a group consisting of:
a) expressing said first framework bearing capability by at least one of said operative faces by translating said bearing operative face in the first framework third dimension negative direction;
b) expressing said displacing mitigability by at least one of said operative faces by translating said mitigable operative face in the first framework third dimension negative direction;
c) repressing said first framework bearing capability by at least one of said operative faces by translating said bearing operative face in the first framework third dimension positive direction;
d) repressing said displacing mitigability by at least one of said operative faces by translating said mitigable operative face in the first framework third dimension positive direction;
e) providing a conveyance system capable of realizing at least one of the present claim 38 further steps a) through d);
f) and combinations thereof.

39. The impromptuly deployable method of conveying at least one article according to claim 29, said conveyance system comprising at least one set of at least one of said mechanical conveyance facilitators, and at least one set of at least one mechanical displacer capable of facilitating displacing said conveyance system relative to a surface underlying the conveying system, said mechanical displacers' displacing facilitation being selectively arrestable, wherein said set of mechanical conveyance facilitators is utilizable for conveying at least one article relative to said first framework, and said set of mechanical displacers is utilizable for facilitating displacing said conveyance system, when at least partially supporting an article being conveyed, such that at least one article is conveyable by said conveyance system displacing.

40. The impromptuly deployable method of conveying at least one article according to claim 30, wherein said moving mechanical conveyance facilitators are rotatable about axes that are at least partially unconstrained relative to said first framework, at least one of said rotatable conveyance facilitators being variably dispositionable, said mitigability involving at least one of said moving mechanical conveyance facilitators' rotatability, said varying dispositions capable of providing varying degrees of mitigation of said gravitationally related article conveying complications, said method further comprising the step of disposing at least one of said variably dispositionable rotatable conveyance facilitators so as to realize at least one of said degrees of article conveying mitigation.

41. The impromptuly deployable method of conveying at least one article according to claim 30, wherein at least one of said mechanical conveyance facilitators is rotatable, said rotatability being realizable in varying manners, at least one of said manners of realizing said rotatability selected from a group consisting of:
a) by being rotatable about a single axis;
b) by being rotatable about a single axis that is variably dispositionable;
c) by being rotatable about a single axis that is variably dispositionable, said axis dispositions varying by overall translations;
d) by being rotatable about a single axis that is variably dispositionable, said axis dispositions varying by differential translations that translate at least a first portion of said axis differently than at least a second portion of said axis is translated;
e) by being rotatable about at least first and second axes that are not parallel;
f) by being rotatable about an axis with an at least partially unconstrained orientation so that said axis orientations can continuously vary throughout a non-trivial solid angle;
g) by being rotatable about an axis with an unconstrained orientation;
h) by at least one of said mechanical conveyance facilitators having a composite structure incorporating at least first and second rotatable sub-components with separate, nonparallel rotational axes so that said article conveying in a first direction is mitigable by rotation of said first rotatable sub-component and said article conveying in a second direction is mitigable by rotation of said second sub-component;
i) providing a conveyance system capable of at least one of the present claim 41 rotatability variations a) through h);
j) and combinations thereof.

42. The impromptuly deployable method of conveying at least one article according to claim 28 wherein at least one auxiliary conveying functionality capable of affecting at least one conveying process operative parameter is further providable by said conveyance system, further comprising an optional auxiliary conveying functionality utilizing step selected from a group consisting of:
a) modulating at least one operative parameter of at least one of said mitigating and said providing support steps;
b) modulating at least one operative parameter of at least one of said mitigating and said providing support steps, said modulating being effectible at least one of selectively, and autonomously in response to at least one of said operative parameters;
c) impeding, at least partially, at least one portion of said conveying process;
d) impeding, at least partially, at least one portion of said conveying process, said impeding being effectible at least one of selectively, and autonomously in response to at least one of said operative parameters;
e) augmenting, at least partially, at least one portion of said conveying process;
f) augmenting, at least partially, at least one portion of said conveying process, said augmenting being effectible at least one of autonomously in response to at least one of said operative parameters and selectively;
g) providing a conveyance system capable of at least one of the present claim 42 optional utilizing steps a) through f);
h) and combinations thereof.

43. The impromptuly deployable method of conveying at least one article according to claim 28 wherein at least one ancillary mechanical conveyance assistor capable of mechanically assisting said mitigating of at least one gravitationally related article conveyance complication is further providable by said conveyance system, said mechanical assisting operating by at least one of:
augmenting said mechanical conveyance assistors' mitigating action, and
acting separately from, and at least partially in concert with, said mechanical conveyance facilitators mitigating action;
said method further comprising the optional step of utilizing said ancillary mechanical conveyance assistor for at least a portion of said supported section of the conveyance path.

44. The impromptuly deployable method of conveying at least one article according to claim 43 wherein said ancillary mechanical conveyance assistor provides a mechanical interface suitable for communicating at least one of said conveyance system's supporting and facilitating actions to the articles being conveyed, said interface being movable in concert with the articles being conveyed, said concerted movement of the interface and articles being conveyed providing capabilities for at least one of said mechanical conveyance facilitators to facilitate said conveyance without directly contacting said article,
said method further comprising an optional step of utilizing said ancillary mechanical conveyance assistor for at least a portion of said article conveying.

45. The impromptuly deployable method of conveying at least one article according to claim 44 wherein said ancillary mechanical conveyance assistor is at least partially separable from the balance of said conveyance system, said separability enabling said ancillary mechanical conveyance assistor to provide at least one capability selected from a group consisting of:
a) suitability, when in an at least partially separated state, for interfacing with at least one article;
b) suitability, when in an at least partially separated state, for aiding in translating at least one article;
c) suitability, when in an at least partially separated state, for aiding in controlling at least one article;
d) suitability, when in an at least partially separated state, for aiding initiation of at least partial support of at least one article by the balance of said conveyance system;
e) suitability, when in an at least partially separated state, for aiding conclusion of at least partial support of at least one article by the balance of said conveyance system;
f) and combinations thereof;
said method further comprising a first optional step of utilizing at least one of said separability enabled mechanical conveyance assistor capabilities, and
a second optional step of providing a conveyance system capable of at least one of the present claim 45 optional ancillary conveyance assisting capabilities a) through f).

46. The impromptuly deployable method of conveying at least one article according to claim 28, wherein said conveyance system further comprises at least one transporter component with which said conveyance system is transportable so that the conveyance system is capable of effecting said article conveying both by translating at least one of said articles relative to the conveyance system, and by transporting said conveyance system as a whole when it is at least partially supporting at least one of said articles,
said method further comprising an optional step of conveying at least one article by transporting said conveyance system when said conveyance system is at least partially supporting said articles.

47. The impromptuly deployable method of conveying at least one article according to claim 28, wherein at least one adjustable portion of said first framework is selectively orientatable without substantially altering the orientation of the balance of said conveyance system so that at least one portion of said supported section of the conveyance path is modifiable by said first framework adjustable portion's selective orientating,
said method further comprising an optional step of selecting an orientation of at least a portion of the supported section of said conveyance path by selectively orientating said adjustable portion of the first framework.

48. The impromptuly deployable method of conveying at least one article according to claim 28, wherein at least first and second conveyance systems are linkable so that an extended conveyance path is definable by a plurality of said linked conveyance systems,
said method further comprising the optional step of extending said conveyance path by linking at least said first and second conveyance systems.

49. The impromptuly deployable method of conveying at least one article according to claim 28, wherein said conveyance system further comprises at least one supplementary component that is capable of at least one non-conveying function, at least one of said supplementary components and non-conveying functions being selected from a group consisting of:
a) a ladder;
b) an implement securing assembly;
c) a workbench;
d) a work-object securing apparatus;
e) a work-surface;
f) a vise;
g) a toolbox;
h) a filing implement;
i) a sanding implement;
j) a scoring device;
k) a metal-working implement;
l) a wood-working implement;
m) a stone-working implement;
n) a plastic-working implement;
o) a material-working implement;
p) a lighting source;
q) a fastening implement;
r) a cutting implement;
s) a joining implement;
t) an assembling implement;
u) a testing implement;
v) a ruler;
w) a scale;
x) a measuring implement;
y) a storage container;
z) a floatation device;
aa) and combinations thereof.

50. The impromptuly deployable method of conveying at least one article according to claim 49 wherein said supplementary component is at least partially separable from the balance of said conveyance system,
said method further comprising an optional step of separating said supplementary component from the balance of the conveyance system so that said supplementary component is utilizable for a non-conveying function.

51. The impromptuly deployable method of conveying at least one article according to claim 29, wherein said reconfigurability is realizable by said conveyance system having a modular constitution, said method further comprising an optional step of reconfiguring said conveyance system by altering at least a portion of its modular constitution.

52. The impromptuly deployable method of conveying at least one article according to claim 51, said modular constitution generally involving detachable interconnections between said first framework and at least one additional modular constituent, said detachable interconnections being at least one of direct and indirect, at least one of said modular constituents being selected from a group consisting of:
a) a second framework;
b) at least one supplementary component that is capable of at least one non-conveying function;
c) at least one complementary mechanical conveyance facilitator;
d) at least one mechanical conveyance system transporter component;
e) at least one specialized conveying implement that is particularly suitable for conveying at least one specific type of article;
f) at least one conveying process modulator;
g) at least one ancillary mechanical conveyance assistor;
h) at least one auxiliary conveying functionality;
i) and combinations thereof;
said method further comprising at least one optional step of reconfiguring said conveyance system by altering at least one portion of its modular constitution, said altering involving at least one of said constituent variability and said arrangement alterability.

53. A composite conveyance apparatus comprising:
at least one conveyance facilitating assembly and at least one supplementary component interrelated with a first framework,
said first framework and conveyance facilitating assembly suitable for at least partially supporting at least one article being conveyed and at least one article conveyance complication mitigable by said conveyance facilitating assembly, and
at least one conveyance-distinct function pertinent to a projected general realm of conveyance-related purposes providable by said supplementary component;
said mitigability effectible via at least one conveyance facilitating assembly element that is rotatable relative to said first framework, said rotatable element involved in communicating to said article at least a portion of said partial support so that said element's rotation, when communicating said support, facilitates conveyance of the article relative to said first framework; and
said supplementary component and said conveyance facilitating assembly, when operable, are abeyant during said article conveying and said conveyance-distinct functioning, respectively.

54. The composite conveyance apparatus according to claim 53, wherein at least one of said supplementary component and conveyance-distinct function is selected from a group consisting of:
a) a ladder;
b) an implement securing assembly;
c) a workbench;
d) a work-object securing apparatus;
e) a work-surface;
f) a vise;
g) a toolbox;
h) a filing implement;
i) a sanding implement;
j) a scoring device;
k) a metal-working implement;
l) a wood-working implement;
m) a stone-working implement;
n) a plastic-working implement;
o) a material-working implement;
p) a lighting source;
q) a fastening implement;
r) a cutting implement;
s) a joining implement;
t) an assembling implement;
u) a testing implement;
v) a ruler;
w) a scale;
x) a measuring implement;
y) a storage container;
z) a floatation device;
aa) and combinations thereof.

55. The composite conveyance apparatus according to claim 53, wherein said supplementary component is further capable of realizing a composite conveyance apparatus transporting function, said transporting function involving at least one transporter constituent of the supplementary component, said transporter constituent being rotatable relative to the balance of the composite conveyance apparatus so that when the transporter constituent is bearing at least a portion of the weight of said composite conveyance apparatus, the composite conveyance apparatus is transportable by rotation of the transporter constituent.

56. The composite conveyance apparatus according to claim 53, wherein said conveyance facilitating assembly element is selected from a group consisting of:
a) a wheel;
b) a ball bearing;
c) a conveyor belt;
d) a gear;
e) a gearing;
f) a rotatable axle;
g) a spindle;
h) a bearing;
i) a spheroid;
j) an oblong spheroid;
k) an at least partially rotatable composite assembly;
l) a reciprocating mechanism;
m) and combinations thereof.

57. The composite conveyance apparatus according to claim 53, wherein said conveyance facilitating element further comprises at least one mechanical interface suitable for communicating at least a portion of at least one of said article supporting and said article conveyance complication mitigating to said article, said mechanical interface being movable in concert with the articles being conveyed, said concerted movement of the interface and articles being conveyed providing capabilities for at least one of said mechanical conveyance facilitators to facilitate said conveyance without directly contacting said article.

58. The composite conveyance apparatus according to claim 57, wherein said mechanical interface incorporates an interfacing aspect that contributes to said communicating to the article being conveyed, said interfacing aspect corresponding in at least one of function and structure to at least one implement selected from a group consisting of:
a) a conduit;
b) a vessel;
c) a container;
d) a tray;
e) a plate;
f) a rack;
g) a frame;
h) a bracket;
i) a drawer;
j) a strap;
k) a cable;
l) a receptacle;
m) a chassis;
n) an armature;
o) a carton;
p) a basket;
q) a casing;
r) a box;
s) a wrapper;
t) a cover;
u) a hook;
v) a clamp;
w) a fastener;
x) a support plate;
y) a shelf;
z) a pallet;
aa) a webbing;
bb) a bin;
cc) a bag;
dd) a capsule;
ee) a jacket;
ff) a chamber;
gg) and combinations thereof.

59. The composite conveyance apparatus according to claim 53 optionally further comprising at least one conveying process influencing mechanism, said conveying process influencing mechanism providing at least one effect chosen from a group consisting of:
a) at least partially affecting a rate of conveying of at least a portion of the conveying process;
b) at least partially enhancing a rate of conveying of at least a portion of the conveying process;
c) at least partially governing a rate of conveying of at least a portion of the conveying process;
d) at least partially affecting at least one dynamic parameter of at least a portion of the conveying process;
e) at least partially offsetting at least one dynamic complication of at least a portion of the conveying process;
f) at least partially governing at least one dynamic parameter of at least a portion of the conveying process;
g) and combinations thereof.

60. A topographically adaptable article conveyance system comprising:
an articulated framework interrelated with at least one mechanical conveyance facilitator capable of mitigating at least one gravitationally related article conveyance complication,
said articulated framework comprising a serial plurality of interconnected framework segments defining at least one article conveyance path, at least one interconnection of adjacent framework segments enabling their repositioning relative to each other, said framework segments' relative repositioning enabling repositioning of said article conveyance path,
said at least one mechanical conveyance facilitator's interrelation with said framework segments enabling repositioning of the at least one mechanical conveyance facilitator concomitantly with said conveyance path repositioning, said concomitant mechanical conveyance facilitator repositioning enabling article conveyance along said repositioned conveyance path to also be facilitated by said at least one mechanical conveyance facilitator;
wherein said repositionings effectible by a framework first segment, relative to an adjacent framework second segment, include at least one of a first and a second alteration of the framework first segment's orientation, said first and second framework first segment orientation alterations involving rotations in first and second non-parallel planes, respectively.

61. The topographically adaptable article conveyance system according to claim 60, wherein said framework segment relative orientation alterations are capable of effecting at least first and second alterations of at least one portion of said article conveyance path, said conveyance path portion first alteration varying said conveyance path portion's inclination relative to the vertical plane, and said conveyance path portion second alteration varying said conveyance path portion's inclination relative to the horizontal plane.

62. The topographically adaptable article conveyance system according to claim 60, wherein said articulated framework is at least partially adaptable to the topography of at least one underlying support surface so that the articulated framework's defined conveyance path is also at least partially adaptable to said underlying support surface's topography, and said framework segments' interrelation with said at least one mechanical conveyance facilitator enabling said mechanical conveyance facilitators to mitigate at least one gravitationally related article conveyance complication for an article being conveyed along said topographically adapted conveyance path.

63. The topographically adaptable article conveyance system according to claim 60, wherein said framework segments have capabilities of serially attaching to and detaching from other framework segments, said defined conveyance path being increasable and decreasable by said framework segments' attaching and detaching, respectively, said framework segment attaching further enabling said articulated framework to form a closed loop for surrounding at least one article being conveyed such that conveyance of said article is effectible by circulation of said articulated framework closed loop about said at least one article being conveyed.
